(19) United States
(12) Patent Application Publication
(10) Pub. No.: US 2003/0091657 A1
(43) Pub. Date: May 15, 2003

(54) Plant acaricidal compositions and method using same

(76) Inventor: Helene Chiasson, Saint-Athanase (CA)

Correspondence Address: NEEDLE & ROSENBERG P C, 127 PEACHTREE STREET N E, ATLANTA, GA, 30303-1811, US

(21) Appl. No.: 10/195,131

(22) Filed: Jul. 12, 2002

Related U.S. Application Data
(63) Continuation-in-part of application No. 09/527,258, filed on Mar. 17, 2000.

(51) Int. Cl. A61K 35/78

(52) U.S. Cl. 424/725

(57) ABSTRACT

The present invention relates to acaricides. More particularly, the present invention relates to botanical acaricides. In particular, the present invention relates to compositions and methods for controlling plant-infesting acari with plant extracts and notably with compositions comprising oil extracts derived from plant material. The invention further relates to compositions comprising such extracts as acaricidal compositions and providing the advantages of minimal development of resistance thereto, minimal toxicity to mammals, minimal residual activity and environmental compatibility. The compositions of the present invention further display insecticidal activity on plant-infesting insects. The plant acaricidal composition comprises α-terpinene, ρ-cymene, limonene, carvacrol, carveol, nerol, thymol, and carvone.

### CROSS REFERENCE TO RELATED APPLICATION

This application is a Continuation-In-Part of U.S. Application Serial No. 09/527,258, filed Mar. 17, 2000, the entire disclosure of which is incorporated herein by reference.

### FIELD OF INVENTION

The present invention relates to the field of pesticides for controlling plant-infesting pests.

### BACKGROUND OF THE INVENTION

Plant feeding mites are among the most voracious phytophagous pests of crops (Dekeyser and Downer, 1994). To combat these pests, synthetic pesticides have been developed. These synthetic chemical pesticides, however, often have detrimental environmental effects that are harmful to humans and other animals and therefore do not meet the guidelines developed by most Integrated Pest Management programs. Moreover, resistance to these products has been found to develop with many of the new products put on the market (Georghiou, 1990; Nauen et al., 2001).

Although resistance follows a highly complex genetic and biochemical process, it can generally develop rapidly with synthetic products because their active ingredients rely on one or more molecules of the same class. The organism can therefore respond to the toxin by developing physiological, behavioral or morphological defense mechanisms to neutralize the effect of the molecule (Roush and MacKenzie, 1987).

Spider mites, in particular, are extremely difficult to control with pesticides. Tetranychus urticae (the two-spotted spider mite), for example, has accumulated a considerable number of genes conferring resistance to all major classes of acaricides. Resistance to many registered acaricides have been reported, for example, resistance has been reported to hexythiazox, abamectin, and clofentezine (Beers et al., 1998; Herron et al., 1993; Grosscurt et al., 1994). Furthermore, many of these pesticides have been found to exacerbate pest infestation by destroying the natural predators of mites (U.S. Pat. No. 5,839,224). Additionally, many synthetic insecticides have been found to stimulate mite reproduction. For example, it was found that mites reproduce many times faster when exposed to carbaryl, methyl parathion, or dimethoate in the laboratory than untreated populations (Flint, 1990).

As a result, there are very few pesticides remaining that are effective against spider mites (Georghiou, 1990). In the Farm Chemical Handbook (Meister, 1999), for example, only 48 products out of a total of 2,050 listed acaricides and insecticides (or 2.4%), were identified as acaricides and only 69 of these products (or 3.4%) were identified as both acaricides and insecticides.

As an alternative, botanical pesticides offer the advantage of being naturally derived compounds that are safe to both humans and the environment. Specifically, botanical pesticides offer such advantages as being inherently less toxic than conventional pesticides, generally affecting only the target pest and closely related organisms, and are often effective in very small quantities. In addition, botanical pesticides often decompose quickly and, therefore, are ideal for use as a component of Integrated Pest Management (IPM) programs.

There are few published reports of the acaricidal properties of botanical pesticides. For example, U.S. Pat. No. 4,933,371 describes the use of saponins extracted from various plants (i.e., yucca, quillaja, agave, tobacco and licorice) as acaricides. This patent also describes the use of linalool extracted from the oil of various plants such as Ceylon's cinnamon, sassafras, orange flower, bergamot, Artemisia balchanorum, ylang ylang, rosewood and other oil extracts as acaricides. These methods, however, require the extraction of one active substance from the plant which often does not meet desired levels of toxicity towards acari. Plant essential oils are a complex mixture of compounds of which many can be biologically active against insect and mite pests, the compounds acting individually or in synergy with each other, to either repel or kill the pests by contact. These components are plant secondary metabolites or allelochemicals produced by plants as a defense mechanism against plant feeding pests (Ceske and Kaufman, 1999). Because of the complexity of the mixture, it has been observed that pests do not easily develop resistance to these products as they can to synthetic pesticides or botanical pesticides comprising a single active compound. In this respect, Feng and Isman (1995) demonstrated that repeated treatments of pure azadirachtin, a major active constituent of neem oil, against the green peach aphid led to a 9-fold resistance after 40 generations. However, repeated exposure during 40 generations to crude neem extracts did not lead to resistance.

There remains a need to provide new and effective pesticidal products which overcome the problem of products known in the art. For example, there remains a need for acaricidal compositions which are less likely to enable acari to develop resistance thereto. There also remains a need to provide a method to combat pests at a locus, using a composition which is not toxic to animals, especially to mammals, nor to any beneficial predator/parasitoid insects.

### BRIEF DESCRIPTION OF THE DRAWINGS

FIG. 1 shows the chemical content of three lots or pools of oil samples extracted from whole plant parts above root (00MC-21P, 00MC-24P and 00M-29P).

FIG. 2 shows the average mortality (%) of the two-spotted spider mite (TSSM: Tetranychus urticae) when tested with solutions of individual compounds present in the essential oil of Chenopodium ambrosioides. Results adjusted for control mortality with Abbott's formula.

FIG. 3 shows the average mortality (%) of the greenhouse whitefly (GWF; Trialeurodes vaporaiorum) when tested with solutions of individual compounds present in the essential oil of Chenopodium ambrosioides. Results adjusted for control mortality with Abbott's formula.

FIG. 4 shows adult spider mite (Tetranychus urticae) mortality obtained with bioassays using the RTU formulation of Chenopodium ambrosioides and commercial preparations of natural and synthetic insecticides.

FIG. 5 shows spider mite egg (Tetranychus urticae) mortality, using the RTU formulation of Chenopodium ambrosioides oil.

FIG. 6 shows spider mite nymph (Tetranychus urticae) mortality, using the RTU Chenopodium extract formulation and commercial preparations of synthetic and natural products.

FIG. 7 shows the mortality of adult spider mites 48 h following introduction on faba bean leaves treated one hour previously with the RTU formulation and selected natural acaricides

FIG. 8 shows red mite, Panonychus ulmi mortality, using the RTU formulation.

FIG. 9 shows insect mortality (%) obtained with bioassays using the RTU formulation of Chenopodium ambrosioides.

FIG. 10 shows mortality of adult female twospotted spider mites 48 hours following applications.

FIG. 11 shows mortality of adult female European red mite 24 hours following applications.

FIG. 12 shows egg hatch (%) of the twospotted spider mite, 10 days following applications.

FIG. 13 shows egg hatch (%) of European red mite 10 days following applications.

FIG. 14 shows mortality of adult female two-spotted spider mites 48 hours following introduction on leaf discs treated with UDA-245 and Dicofol one hour previously.

FIG. 15 shows mortality of green peach aphids (Myzus persicae (Sulz.)) 48 hours following application of 0.125, 0.25, 0.5, 1.0 and 2.0% concentrations of formulation UDA-245 and the commercially available bioinsecticides Neem Rose Defense® and Safer's Trounce®

FIG. 16 shows lethal concentrations (LC₅₀ and LC₉₀) in % of UDA-245 for the green peach aphid (Myzus persicae (Sulz.)) calculated with 48 hour mortality data.

FIG. 17 shows average number of green peach aphids (Myzus persicae (Sulz.)) per cm² of treated Verbena speciosa shoot following application of 0.25, 0.50 and 1.0% concentrations of UDA-245 and the commercially available bioinsecticides Neem Rose Defense® and Safer's Trounce®

FIG. 18 shows mortality of Western flower thrips (Frankliniella occidentalis (Perg.)) 24 hours following application of six concentrations (0.05, 0.125, 0.18, 0.25, 0.5 and 1.0 %) of formulation UDA-245 and the commercially available bioinsecticides Neem Rose Defense® and Safer's Trounce®

FIG. 19 shows lethal concentrations (LC₅₀ and LC₉₀) in mg/cm² of UDA-245 for the Western flower thrips (Frankliniella occidentalis (Perg.)) calculated with 24 hour mortality data.

FIG. 20 shows average number of Western flower thrips/cm² (WFT:Frankliniella occidentalis (Perg.)) per treatment as a percentage of thrips present on leaves treated with the control during a greenhouse bioassay using two concentrations (0.25 and 1.0 %) of UDA-245 and two commercially available bioinsecticides Neem Rose Defense® and Safer's Trounce®

FIG. 21 shows mortality of greenhouse whiteflies (Trialeurodes vaporariorum (Westw.)) 20 hours following application of five concentrations (0.0625, 0.125, 0.25, 0.5 and 1%) of formulation UDA-245 and the commercially available insecticides Neem Rose Defense® Safer's Trounce® and Thiodan®

FIG. 22 shows lethal concentrations (LC₅₀ and LC₉₀) in mg/cm² of UDA-245 for the greenhouse whitefly (Trialeurodes vaporariorum (Westw.)) calculated with 20 hour mortality data.

FIG. 23 shows mortality of Encarsia formosa 24 hours following application of four concentrations (0.0625, 0.125, 0.25, 0.5 and 1.0%) of formulation UDA-245 and the commercially available bioinsecticides, Neem Rose Defense® and Safer's Trounce®

FIG. 24 shows mean mortality (%) of Amblyseius fallacis adult females following the direct application of several concentrations of UDA-245 and commercially available insecticides.

FIG. 25 shows contact toxicity of UDA-245 oil formulation on adult females of Amblyseius fallacis. Probit analysis.

FIG. 26 shows mean percent mortality of Phytoseiulus persimilis adult females to different insecticide treatments.

FIG. 27 shows overall percent mean mortality of adult wasps Aphidius colemani following direct application with UDA-245 and commercially available insecticides.

FIG. 28 shows male and female mean mortality (%) of Aphidius colemani adult wasps following direct application with UDA-245 and commercially available insecticides.

FIG. 29 shows contact toxicity of UDA-245 oil formulation on adult wasps Aphidius colemani. Probit analysis.

FIG. 30 shows mortality of adult wasps Aphidius colemani following exposure to UDA-245 and commercially available insecticide residues.

FIG. 31 shows probit analysis of adult wasps Aphidius colemani 24H and 48H following exposure to UDA-245 residues.

FIG. 32 shows the effect of treatment on Aphidius colemani emergence from treated mummies.

FIG. 33 shows fecundity assessment of female Aphidius colemani following contact with UDA-245 residues.

FIG. 34 shows mean mortality of Orius insidiosus second instar nymphs following application with UDA-245 and commercially available insecticides.

FIG. 35 shows mean mortality of Orius insidiosus adults following UDA-245 and other insecticide treatments.

FIG. 36 shows fecundity of Orius insidiosus females surviving insecticide treatments.

FIG. 37 shows probit analysis of Orius insidiosus second instar nymphs following application with UDA-245.

FIG. 38 shows probit analysis of Orius insidiosus adults following application with UDA-245.

FIG. 39 shows the major compounds present in Artemisia absinthium oil extracted by MAP, DW, and DSD.

FIG. 40 shows the major compounds present in Tanacetum vulgare oil extracted by MAP, DW, and DSD.

FIG. 41 shows the percent adult Tetranychus urticae mortality 48 h following treatments with Artemisia absinthium oil extracted by MAP, DW, and DSD.

FIG. 42 shows the probit analysis of adult Tetranychus urticae mortalities 48 h following treatments with Artemisia absinthium oil extracted by MAP, DW, and DSD.

FIG. 43 shows the percent adult Tetranychus urticae mortality 48 h following treatments with Tanacetum vulgare oil extracted by MAP, DW, and DSD.

FIG. 44 shows the probit analysis of adult Tetranychus urticae mortalities 48 h following treatments with Tanacetum vulgare oil extracted by DW and DSD.

### SUMMARY OF THE INVENTION

In accordance with one aspect of the invention there is provided an essential oil extract derived from plant material comprising, α-terpinene, ρ-cymene, limonene, carvacrol, carveol, nerol, thymol, and carvone, and having acaricidal activity.

In accordance with another aspect of the invention there is provided an essential oil extract derived from plant material comprising, α-terpinene, ρ-cymene, limonene, carvacrol, carveol, nerol, thymol, and carvone, and having insecticidal activity.

In accordance with another aspect of the invention there is provided an essential oil extract derived from plant material comprising, α-terpinene, ρ-cymene, limonene, carvacrol, carveol, nerol, thymol, and carvone, and having fungicidal activity.

In accordance with another aspect of the invention there is provided a pesticidal composition for the control of phytophagous acari comprising, a suitable carrier, and an effective amount of a plant-derived essential oil extract, wherein said extract comprises α-terpinene, ρ-cymene, limonene, carvacrol, carveol, nerol, thymol and carvone.

In accordance with a further aspect of the invention there is provided a pesticidal composition for the control of phytophagous insects, comprising an effective amount of a plant-derived essential oil extract comprising α-terpinene, ρ-cymene, limonene, carvacrol, carveol, nerol, thymol and carvone, in combination with a suitable carrier.

In accordance with a further aspect of the invention there is provided a fungicidal composition for the control of plant fungi, comprising an effective amount of a plant-derived essential oil extract comprising α-terpinene, ρ-cymene, limonene, carvacrol, carveol, nerol, thymol and carvone, in combination with a suitable carrier.

In accordance with another aspect of the invention there is provided a method for producing an essential oil extract derived from plant material for use in controlling plant pests comprising:

(a) harvesting the plant material;

(b) extracting the essential oil extract by steam distillation; and

(c) recuperating the essential oil extract.

### DETAILED DESCRIPTION OF THE INVENTION

Definitions

Unless defined otherwise, all technical and scientific terms used herein have the same meaning as commonly understood by one of ordinary skill in the art to which this invention belongs.

“Pests” refers to organisms that infest plants and can impact plant health and may include for example, acari, insects, fungi, parasites, and microbes.

“Mite” refers broadly to plant acari. Similarly, “acari” means plant infesting acari or phytophagous acari such as, but not limited to, the two-spotted spider mite (Tetranychus urticae).

“Locus” means a site which is infested or could be infested with acari and/or insects or other pests and may include, but is not restricted to, domestic, agricultural, and horticultural environments.

“Essential Oil Extract” means the volatile, aromatic oils obtained by steam or hydro-distillation of plant material and may include, but are not restricted to, being primarily composed of terpenes and their oxygenated derivatives. Essential oils can be obtained from, for example, plant parts including, for example, flowers, leaves, seeds, roots, stems, bark, wood, etc.

“Active Constituents” means the constituents of the essential oil extract to which the pesticidal activity, for example, acaricidal, insecticidal, and/or fungicidal activity is attributed. The essential oil extract of the present invention generally comprises the active constituents including: α-terpinene, ρ-cymene, limonene, carvacrol, carveol, nerol, thymol, and carvone.

The term “partially purified”, when used in reference to an essential oil extract means that the extract is in a form that is relatively free of proteins, nucleic acids, lipids, carbohydrates or other materials with which it is naturally associated in a plant. As disclosed herein, an essential oil extract of the invention is considered to be partially purified. In addition, the individual components of the essential oil extract can be further purified using routine and well known methods as provided herein.

Other chemistry terms herein are used according to conventional usage in the art, as exemplified by The McGraw-Hill Dictionary of Chemical Terms (ed. Parker, S., 1985), McGraw-Hill, San Francisco, incorporated herein by reference.

The present invention provides for essential oil extracts derived from plant material with pesticidal activity. In one embodiment, the essential oils of the present invention have acaricidal activity. In another embodiment, the essential oil extracts of the present invention has insecticidal activity. In another embodiment, the essential oil extracts of the present invention has fungicidal activity.

The present invention also provides for the use of the essential oil extracts to produce pesticidal compositions and formulations demonstrating acaricidal, insecticidal, and/or fungicidal activity to control plant-infesting pests. Such extracts, compositions, and formulations of the present invention are derived from plant sources preferably by steam or hydro-distillation extraction methods from said plant material. In one embodiment, these extracts, compositions, and formulations can be used to control pests, such as plant-infesting acari, at any locus without detriment to the environment or other beneficial insects. In a further aspect, these extracts, compositions, and formulations can be incorporated into Integrated Pest Management programs to control plant-infesting pests.

Plant Material

Plant material that may be used in the present invention includes part of a plant taken individually or in a group and may include, but is not restricted to, the leaf, flowers, roots, seeds, and stems. As is known by persons skilled in the art, the chemical composition and efficacy of an essential oil extract varies with the phenological age of the plant (Jackson et al., 1994), percent humidity of the harvested material (Chialva et al., 1983), the plant parts chosen for extraction (Jackson et al., 1994; and Chialva et al., 1983), and the method of extraction (Perez-Souto, 1992). Methods well-known in the art can be adapted by a person of ordinary skill in the art to achieve the desired yield and quality of the essential oil extract of the present invention. In one embodiment, plant material is derived from the genus Chenopodium. In a further embodiment, the plant material is derived from Chenopodium ambrosioides.

Harvesting the Plant Material for Extraction and Optional Storage Treatment

The plant material may be used immediately after harvesting. In one embodiment the fresh plant material having a humidity level of >75% is used. Otherwise, it may be desirable to store the plant material for a period of time, prior to performing the extraction procedure(s). In another embodiment wilted plant material having a humidity level of 40 to 60% is used. In another embodiment dry plant material having a humidity level of <20%) is used. In a further embodiment, the plant material is treated prior to storage. In such cases, the treatment may include drying, freezing, lyophilisizing, or some combination thereof.

Pre-Treatment of Plant Material

In addition to such parameters as the phenological age of the plant, the percent humidity of the harvested material, the plant parts chosen for extraction, and the method of extraction, the chemical composition and efficacy of an essential oil extract may be affected by pre-treatment of the plant material. For example, when a plant is stressed, several biochemical processes are activated and many new compounds, in addition to those constitutively expressed, are synthesized as a response. In addition to pests, fungi, and other pathogenic attacks, stressors include drought, heat, water and mechanical wounding. Moreover, persons of skill in the art will also recognize that combinations of stressors may be used. For example, the effects of mechanical wounding can be increased by the addition of compounds that are naturally synthesized by plants when stressed. Such compounds include jasmonic acid (JA). In addition, analogs of oral secretions of insects can also be used in this way (Baldwin, I. T. 1999), to enhance the reaction of plants to stressors.

In one embodiment, the essential oil extracts of the present invention are derived from plant material which has been pre-treated, for example by stressing the plant by chemical or mechanical wounding, drought, heat, or cold, or a combination thereof, before plant material collection and extraction.

Extraction of the Essential Oil Extract and Validation of Constituents

Essential oil extracts can be extracted from plant material by standard techniques known in the art. A variety of strategies are available for extracting essential oils from plant material, the choice of which depends on the ability of the method to extract the constituents in the extract of the present invention. Examples of suitable methods for extracting essential oil extracts include, but are not limited to, hydro-distillation, direct steam distillation (Duerbeck, 1993), solvent extraction, and Microwave Assisted Process (MAP™) (Belanger et al., 1991).

In one embodiment, plant material is treated by boiling the plant material in water to release the volatile constituents into the water which can be recovered after distillation and cooling. In another embodiment, plant material is treated with steam to cause the essential oils within the cell membranes to diffuse out and form mixtures with the water vapor. The steam and volatiles can then be condensed and the oil collected. In another embodiment, organic solvents are used to extract organically soluble compounds found in essential oils. Non-limiting examples of such organic solvents include methanol, ethanol, hexane, and methylene chloride. In a further embodiment, microwaves are used to excite water molecules in the plant tissue which causes cells to rupture and release the essential oils trapped in the extracellular tissues of the plant material.

To confirm the presence of the constituents of the present invention in the essential oil extract, a variety of analytical techniques well known to those of skill in the art may be employed. Such techniques include, for example, chromatographic separation of organic molecules (e.g., gas chromatography) or by other analytical techniques (e.g., mass spectroscopy) useful to identify molecules falling within the scope of the invention.

Determination of Pesticidal Activity of an Essential Oil Extract

Following extraction of a candidate essential oil extract of the invention, it may be desirable to test the efficacy of the extracts for pesticidal activity. Any number of tests familiar to a worker skilled in the art may be used to test the pesticidal activity of the extracts, compositions, and formulations of the invention.

1. Determination of Acaricidal Activity of an Essential Oil Extract

Acaricidal activity of an essential oil extract may be evaluated by using a variety of bioassays known in the art (Ebeling and Pence, 1953; Ascher and Cwilich, 1960; Dittrich, 1962; Lippold, 1963; Foot and Boyce, 1966; Anonymous, 1968; and Busvine, 1958).

Contact efficacy with the adult stage

One exemplary method that may be used tests the contact efficacy of the essential oil extract, or formulations thereof, with the adult stage of a mite species. For example, adult mites may be placed on their dorsum with a camel hair brush on a double-sided sticking tape glued to a 9 cm Petri dish (after Anonymous, 1968). Essential oil extracts and/or formulations may then be applied to the test subjects by spraying with the spray nozzle of a Potter Spray Tower mounted on a stand and connected to a pressure gauge set at 3 psi. Mites that fail to respond to probing with a fine camel hair brush with movements of the legs, proboscis or abdomen are considered dead.

In one embodiment, the contact efficacy of an essential oil extract is determined using the two-spotted spider mite (Tetranychus urticae), at the adult stage, as a model test subject. A person skilled in the art, however, will readily understand that other species of acari can be used.

Ovicidal activity

The ovicidal effect can be determined by treating mite eggs with concentrations of essential oil extracts. For example, adult female T. urticae may be transferred to 2 cm diameter leaf disks cut out of lima bean leaves and left for four hours for oviposition. When at least 20 eggs/disk are laid, adult mites may then be removed. Essential oil extracts and/or formulations may then be applied by spraying the test subjects. Egg hatch is assessed daily and for 10 days following treatment by counting the number of eggs remaining on the leaf disks and the number of live and dead nymphs present. Percent egg hatch is determined with live nymphs only. The nymphs are considered dead if no movement is observed after repeated gentle probing with a single-hair brush.

In one embodiment the ovicidal activity of an essential oil extract is determined with mite eggs of the two-spotted spider mite (Tetranychus urticae), as a model test subject. A person skilled in the art, however, will readily understand that other species of acari can be used.

2. Determination of Insecticidal Activity of an Essential Oil Extract

Similar bioassays can be conducted to evaluate the insecticidal activity of an essential oil extract by utilizing an insect model. In one embodiment, the greenhouse whitefly (Trialeurodes vaporariorum (Westw.)) is used as a model test subject in an insecticide bioassay. For example, Whitefly adults may be glued to a black 5 cm×7,5 cm plastic card sprayed with Tangle-Trap® (Gempler's Co.) to obtain at least 20 active adults per card. Each card is sprayed with the essential oil extract, composition, or formulation and allowed to dry. The cards are then placed sideways on a Styrofoam rack in a closed clear plastic container of 5L with moistened foam on the bottom to keep humidity high (>90 % R.H.). The plastic container is stored in a growth chamber at 24° C. and 16 L:8D photoperiod. Mortality is evaluated 20 hours following treatment by gently probing the whitefly with a single-hair brush under the binocular microscope. Absence of movement (antennae, leg, wing) following probing is recorded as dead. A person skilled in the art, however, will readily understand that other insect species can be used.

3. Determination of Fungicidal Activity of an Essential Oil Extract

Similar bioassays can be conducted to evaluate the fungicidal activity of an essential oil extract by utilizing a fungal model. For example, laboratory tests of fungicidal efficacy may be conducted by incorporating test samples of essential oil extracts, or compositions thereof, in an agar overlay in a Petri dish or on a filter disk placed on top of untreated agar. The system is then challenged with fungal plugs cut from lawns of indicator organisms at the same stage of growth. The plates are incubated at 30° C. for 5-10 days with visual observations and the zone of inhibition measured and recorded. A positive control, i.e., a commercially available fungicide and a negative control, i.e. water may be tested in the same way.

Greenhouse tests may also be employed to evaluate fungicidal efficacy. For example, the effect of the essential oil extracts, or compositions thereof, may be tested on host plants infected by a disease organism such as, for example, Botrytis cinerea, Erysiphe cichoracearum or Sphaerotheca fuliginea, Rhizoctonia solanli, and Phytophthora infestans, by observing the percent damage or presence of lesions on the host plant after treatment and against controls.

Pesticidal Formulations of the Essential Oil Extract

Formulations containing the essential oil extracts of the present invention can be prepared by known techniques to form emulsions, aerosols, sprays, or other liquid preparations, dusts, powders or solid preparations. These types of formulations can be prepared, for example, by combining with pesticide dispersible liquid carriers and/or dispersible solid carriers known in the art and optionally with carrier vehicle assistants, e.g., conventional pesticide surface-active agents, including . emulsifying agents and/or dispersing agents. The choice of dispersing and emulsifying agents and the amount combined is determined by the nature of the formulation and the ability of the agent to facilitate the dispersion of the essential oil extract of the present invention while not significantly diminishing the acaricidal, insecticidal, and/or fungicidal activity of the essential oil extract.

Non-limiting examples of conventional carriers include liquid carriers, including aerosol propellants which are gaseous at normal temperatures and pressures, such as Freon; inert dispersible liquid diluent carriers, including inert organic solvents, such as aromatic hydrocarbons (e.g., benzene, toluene, xylene, alkyl naphthalenes), halogenated especially chlorinated, aromatic hydrocarbons (e.g., chloro-benzenes), cycloalkanes (e.g., cyclohexane), paraffins (e.g., petroleum or mineral oil fractions), chlorinated aliphatic hydrocarbons (e.g., methylene chloride, chloroethylenes), alcohols (e.g., methanol, ethanol, propanol, butanol, glycol), as well as ethers and esters thereof (e.g., glycol monomethyl ether), amines (e.g., ethanolamine), amides (e.g., dimethyl sormamide), sulfoxides (e.g., dimethyl sulfoxide), acetonitrile, ketones (e.g., acetone, methyl ethyl ketone, methyl isobutyl ketone, cyclohexanone), and/or water; as well as inert dispersible finely divided solid carriers such as ground natural minerals (e.g., kaolins, clays, vermiculite, alumina, silica, chalk, i.e., calcium carbonate, talc, attapulgite, montmorillonite, kieselguhr), and ground synthetic minerals (e.g., highly dispersed silicic acid, silicates).

Surface-active agents, i.e., conventional carrier vehicle assistants, that can be employed with the present invention include, without limitation, emulsifying agents, such as non-ionic and/or anionic emulsifying agents (e.g., polyethylene oxide esters of fatty acids, polyethylene oxide ethers of fatty alcohols, alkyl sulfates, alkyl sulfonates, aryl sulfonates, albumin hydrolyzates, and especially alkyl arylpolyglycol ethers, magnesium stearate, sodium oleate); and/or dispersing agents such lignin, sulfite waste liquors, methyl cellulose.

Emulsifiers that can be used to solubilize the essential oil extracts of the present invention in water include blends of anionic and non-ionic emulsifiers. Examples of commercial anionic emulsifiers that can be used include, but are not limited to: Rhodacal™ DS-10, Cafax™ DB-45, Stepanol™ DEA, Aerosol™ OT-75, Rhodacal™ A246L, Rhodafac™ RE-610, and Rhodapex™ CO-436, Rhodacal™ CA, Stepanol™ WAC. Examples of commercial non-ionic emulsifiers that can be used include, but are not limited to:Igepal™ CO-887, Macol™ NP-9.5, Igepal™ CO-430, Rhodasurf™ ON-870, Alkamuls™ EL-719, Alkamuls™ EL-620, Alkamide™ L9DE, Span™ 80, Tween™ 80, Alkamuls™ PSMO-5, Atlas™ G1086, and Tween™ 20, Igepal™ CA-630, Toximul™ R, Toximul™ S, Polystep™ A7 and Polystep™ B1.

If desired, colourants such as inorganic pigments, for example, iron oxide, titanium oxide, and Prussian Blue, and organic dyestuffs, such as alizarin dyestuffs, azo dyestuffs or metal phthalocyanine dyestuffs, and trace elements, such as salts of iron, manganeses, boron, copper, cobalt, molybdenum and zinc may be used.

Spreader and sticking agents, such as carboxymethyl cellulose, natural and synthetic polymers (e.g., gum arabic, polyvinyl alcohol, and polyvinyl acetate), can also be used in the formulations. Examples of commercial spreaders and sticking agents which can be used in the formulations include, but are not limited to, Schercoat™ P110, Pemulen™ TR2, and Carboset™ 514H, Umbrella™, Toximul™ 858 and Latron™ CS-7.

Time-release formulations are also contemplated by the present invention. For example, formulations which have been encapsulated and/or pelletized.

In one embodiment, the formulation can contain a final concentration of 0.125% to 10% by volume of essential oil extract. In another embodiment, the formulation can contain between 0.25% to 2% by volume of essential oil extract. In a further embodiment, the formulation can be a concentrate which can be diluted before use, for example, containing 95% essential oil extract. In yet another embodiment, the formulation can be an emulsifiable concentrate comprising 5% to 50% (by volume) essential oil extract. The person skilled in the art, however, will understand that these concentrations can be modified in accordance with particular needs so that the formulation is acaricidal, insecticidal, and/or fungicidal, but not phytotoxic.

Effect of the Essential Oil Extract or Formulations on Beneficial Insects and Mites

Natural enemies of phytophagous pests include both predators and parasitoids. Predators are generally as large, or larger than the prey they feed on. They are quite capable of moving around to search out their food, and they usually consume many pest insects during their lifetime. Parasitoids, or parasitic insects, are smaller than their prey. One or more parasitoids grow and develop in or on a single host. The host is slowly destroyed as the parasitic larva(e) feed and mature. Such beneficial insects and mites can help prevent or delay the development of pesticide resistance by reducing the number of pesticides required to control a pest. They will also feed on the resistant pests that survive a pesticide application.

Integrated pest management (IPM) programs take advantage of the biological pest control provided by beneficial insects and mites by conserving or augmenting natural enemies. When chemical controls are necessary in an IPM program, pesticides recommended are those that have minimal impact on naturally occurring beneficials.

Essential oil extracts of the present invention, and formulations thereof, may be tested for their effect on beneficial insects and mites, i.e., predators and parasitoids, by means of standardized IOBC (International Organization for Biologicial Control) testing methods (Hassan, 1998b) as illustrated in Example XII.

Use of Essential Oil Extract Formulations

The essential oil extract of the present invention can be used for controlling pests by applying a pesticidally effective amount of the essential oil extract and/or formulation of the present invention to the locus to be protected. The essential oil extract formulations can be applied in a suitable manner known in the art, for example by spraying, atomizing, vaporizing, scattering, dusting, watering, squirting, sprinkling, pouring, fumigating, and the like. The dosage of the essential oil extract is dependant upon factors such as the type of pest, the carrier used, the method of application and climate conditions for application (e.g., indoors, arid, humid, windy, cold, hot, controlled), and the type of formulation (e.g., aerosol, liquid, or solid). The effective dosage, however, can be readily determined by persons of skill in the art.

The essential oil extract of the present invention can be used as part of an Integrated Pest Management program. For example, in conjunction with augmentation of beneficial insects and mites.

The invention now being generally described, it will be more readily understood by references to the following examples, which are included for purposes of illustration only and are not intended to limit the invention unless so stated.

### EXAMPLES

### Example I

### Phytochemical profile of an essential oil extract derived from Chenopodium ambrosioides

Whole plants of C. ambrosioides were harvested. Plant material used for extraction purposes comprised the whole plant above root. Essential oil extracts were extracted from the plant material by steam distillation, i.e., distillation in water (DW) and/or direct steam distillation (DSD).

Distillation in water was carried out in a 380L distillator with a capacity for processing ca. 20 kg of plant material. During the process of DW, plant material was completely immersed in-an appropriate volume of water which was then brought to a boil by the application of heat with a steam coil located at the base of the still body. In DSD, the plant material was supported within the still body and packed uniformly and loosely to provide for the smooth passage of steam through it. Steam was produced by an external generator and allowed to diffuse through the plant material from the bottom of the tank. The rate of entry of the steam was set at (300 ml/min). With both methods, the oil constituents are released from the plant material and with the water vapor are allowed to cool in a condenser to separate into two components, oil and water.

The essential oil extracts were analyzed by capillary gas chromatography (GC) equipped with a flame ionization detector (FID). GC was carried out using a Varian 6000 series Vista and peak areas were computed by a Varian DS 654 integrator. SPB-1 (30 m×0.25 mm Φ, 0.25 μm) and Supelcowax (30 m×0.25 mm Φ, 0.25 μm) fused silca columns were used. Compounds in the sample come off the column at different times in minutes (Rt's or Retention Times) and these are compared to known standards and the compounds can thus be identified. When GC-FID gave ambiguous identification of certain compounds, Mass Spectrometry (MS) was used to compare the mass spectra of the compounds with a database of known spectra.

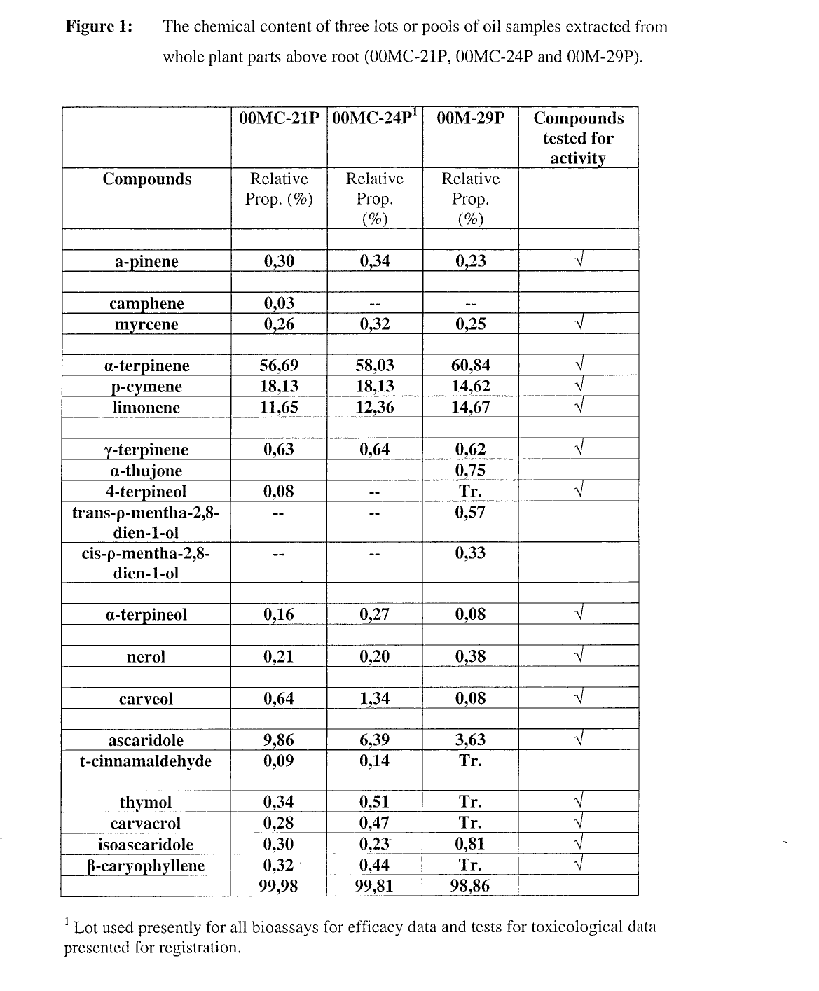

The relative amount of each component of the essential oil extracts was determined for different lots of a variety of C. ambroisiodes. Each lot represents pooled extractions taken from a crop within one harvest date. FIG. 1 shows the phytochemical profile of the essential oil extract taken from three different lots. Lot No. 00MC-21P indicates an ascaridole content of 9.86%; Lot No. 00MC-24P has an ascaridole content of 6.39% and 00MC-29P has an ascaridole content of 3.63%. The activity of the extract is not apparently affected by the variability in relative amount of ascaridole as results from bioassays with these lots suggest.

### Example II

### Determination of the Active Constituents of the Essential Oil Extract

Extensive testing was done in order to determine the active ingredients of the essential oil extract. All compounds present in the oil were tested except for trans-ρ-mentha-2,8-dien-1-ol and cis-ρ-mentha-2,8-dien-1-ol because they were unavailable. All compounds tested were obtained commercially (Sigma-Aldrich) except for ascaridole and iso-ascaridole that were isolated from a sample of our extract by Laboratoires LaSève, Chicoutimi Qc.

Acaricidal activity

Tests with the two-spotted spider mite (TSSM:Tetranychus urticae)

To test acaricidal activity, thirty adult female mites were placed on their dorsum with a camel hair brush on a double-sided sticking tape glued to a 9 cm Petri dish (after Anonymous, 1968). Three dishes were prepared for each concentration of each compound tested and the control (e.g., water) for a total of 90 mites per treatment per treatment day.

One (1) ml of each preparation and of microfiltered water as control was added with a Gilson Pipetman™ P-1000 to the reservoir of the spray nozzle of a Potter Spray Tower mounted on a stand and connected to a pressure gauge set at 3 P.S.I. Petri dishes were weighed before and immediately after each application to calculate the amount of oil deposited (mg/cm²) with each sample tested. The entire procedure was followed three times to give a total number of 270 mites tested with each treatment.

Mite mortality was assessed 24 and 48 h after treatment. Mites that failed to respond to probing with a fine camel hair brush with movements of the legs, proboscis or abdomen were considered dead.

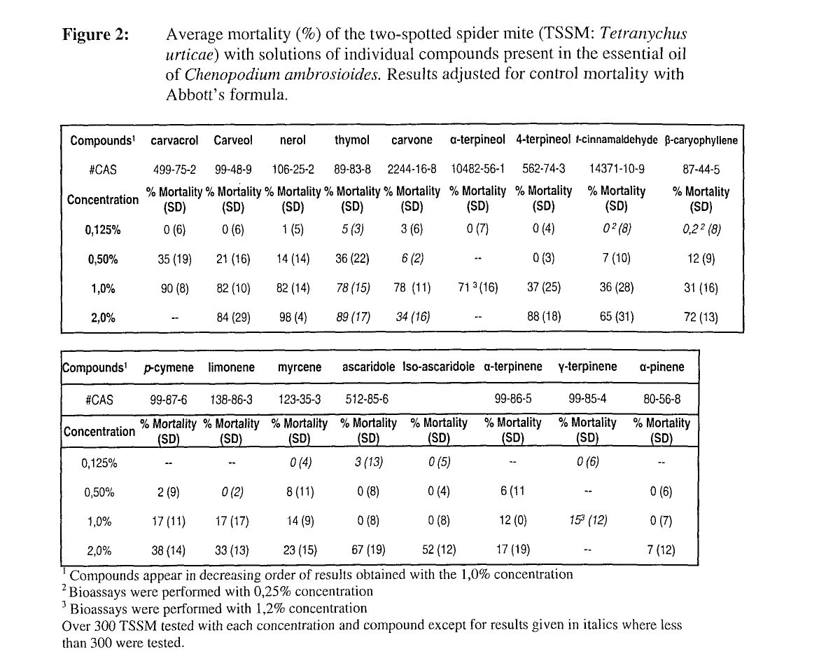

Individual compounds were tested at 0.125, 0.50, 1.0 and 2.0% concentrations with the two-spotted spider mite (TSSM:Tetranychus urticae). Results are illustrated in FIG. 2. Comparisons were made with mortality data obtained with the 1% concentration of each compound and it was observed that carvacrol is the most active compound (90% mortality of TSSM) followed by carveol (82% mortality), nerol (82% mortality), thymol (78% mortality), carvone (78% mortality) and α-terpineol (71% mortality). Other compounds gave less than 40% mortality. No mortality was recorded for ascaridole at 1% . Although 3% mortality was obtained with a solution of 0.125% ascaridole, we believe that this is an erroneous or undependable result because too few individuals were tested (n=125) and the standard deviation is high (13), compared to the higher number of individuals tested at the higher concentrations of this compound (n=300 each at 0.5% and 1.0%) where no mortality was recorded.

The results obtained with individual compounds, do not indicate that the compounds present in large quantities in the oil, i.e α-terpinene, ρ-cymene, limonene, ascaridole, iso-ascaridole, have a great impact on the biological activity of the extract. Mortality obtained with each of these compounds tested at 1% concentration was 17% or less. Ascaridole and iso-ascaridole at 1% concentration had no effect on the spider mite (0% mortality).

Carvacrol, carveol, nerol, thymol and carvone on the other hand may have a much greater impact on the activity of the oil (>70% of TSSM at a I % concentration) even though each of these compounds are present in relatively small quantities (<1%)

Insecticidal activity

Tests with the greenhouse whitefly (GWF: Trialeurodes vaporariorum)

Tests were also done using compounds that had demonstrated the higher degree of activity, i.e. carvacrol, nerol and thymol with the greenhouse whitefly (Trialeurodes vaporariorum) our model bioassay for insecticidal effect.

Whitefly adults were glued to a black 5 cm×7,5 cm plastic card sprayed with Tangle-Trap® (Gempler's Co.) by placing cards directly in the greenhouse colony cage until at least 20 adults have alighted on each card. Cards were observed before spraying under the binocular scope to remove all dead and immobile whiteflies. Only active whiteflies were kept for the experiment. Four cards were used per treatment. Each card was sprayed at 6 psi with 300 μl of emulsion using a BADGER 100-F® (Omer DeSerres Co., Montréal, Canada) paintbrush sprayer mounted on a frame at a distance of 14.5 cm from the spray nozzle in an exhaust chamber. Cards were weighed immediately before and after spraying to calculate the amount of active ingredient deposited in mg/cm². Cards were allowed to dry under the exhaust chamber and then placed sideways on a Styrofoam rack in a closed clear plastic container of 5L with moistened foam on the bottom to keep humidity high (>90 % R.H.). The plastic container was stored in a growth chamber at 24° C. and 16 L:8D photoperiod. This procedure was repeated three times.

Mortality was evaluated 20 hours following treatment by gently probing the whitefly with a single-hair brush under the binocular microscope. Absence of movement (antennae, leg, wing) following probing was recorded as dead. Relative efficacy of the compounds were compared by transforming mortality data to arcsin√p and then subjecting to an ANOVA analysis using SAS® software (SAS Institute 1988).

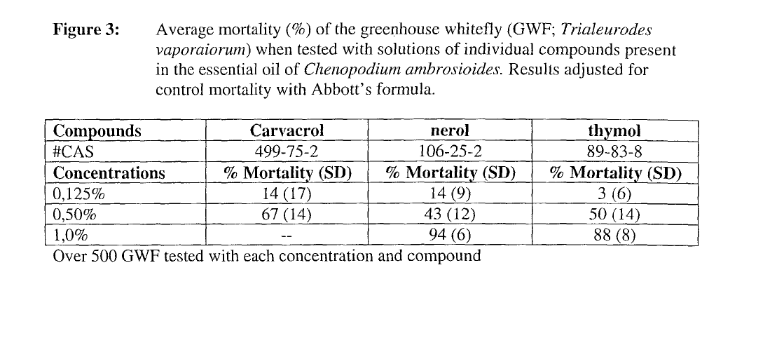

Results with the GWF, shown in FIG. 3, confirm the important biological activity of these three compounds.

### Example III

### Ready-to-use acaricidal formulations

A ready-to-use (RTU) sprayable insecticidal formulation having as the active ingredient an extract of Chenopodium was prepared. In one embodiment, this formulation contains between 0.125% and 10% (by volume) of the essential oil extract, an emulsifier, a spreader and sticking agent, and a carrier.

Examples of RTU formulations without spreader/stickers are as follows.

| Ingredient | Amount (%) | Amount (%) | Amount (%) |
|---|---|---|---|
| Essential oil | 1.00 | 1.00 | 1.00 |
| extract | | | |
| Rodacal IPAM | 0.50 | 0.83 | 0.83 |
| Igepal CA-630 | — | 0.50 | — |
| Macol NP 9.5 | — | — | 0.50 |
| Water | 98.5 | 97.67 | 97.67 |

| Ingredient | Amount (%) | Amount (%) | Amount (%) |
|---|---|---|---|
| Essential oil extract | 1.00 | 1.00 | 1.00 |
| Rhodacal IPAM | 0.83 | 0.83 | 0.83 |
| Igepal CA-630 | 0.50 | 0.50 | 0.50 |
| Carboset 514H | 2.00 | — | — |
| Pemulen TR2 | — | 0.05 | — |
| Schercoat P110 | — | — | 5.00 |
| Propylene glycol | — | 2.00 | — |
| Water | 95.67 | 95.62 | 92.67 |

### Example IV

### Acaricidal efficacy of the essential oil extract (RTU formulation)

Efficacy trials were conducted using the Ready-to-use (RTU) formulation of the present invention. Thirty adult female mites were placed on their dorsum with a camel hair brush on a double-sided adhesive tape glued to a 9 cm Petri dish (after Anonymous 1968). Three dishes were prepared for each concentration of each formulations or products tested and the control, (e.g. water), for a total of 90 mites per treatment per treatment day.

One (1) ml of each preparation and of microfiltered water as control was added with a Gilson Pipetman™ P-1000 to the reservoir of the spray nozzle of a Potter Spray Tower mounted on a stand and connected to a pressure gauge set at 3 P.S.I. Petri dishes were weighed before and immediately after each application to calculate the amount of oil deposited (mg/cm²) with each sample tested.

The ready-to-use formulation was tested according to the method mentioned above to identify the minimum concentration needed for the desired mortality (>95%) at different concentrations (00.125, 0.25, 0.5, 0.75, and 1%) in order to compare the relative efficacy of this RTU formulation and other acaricidal products (synthetic and natural) presently on the market.

The entire procedure was followed three times to give a total number of 270 mites tested with each treatment.

Mite mortality was assessed 24 and 48 h after treatment. Mites that failed to respond to probing with a fine camel hair brush with movements of the legs, proboscis or abdomen were considered dead. In order to obtain LC₅₀ values (Lethal Concentration in mg/cm² is the amount of product needed to kill 50% of the test organism; therefore the lower the LC₅₀ value the more toxic the product) results of the 48 h counts were subjected to Probit analysis using POLO computer program (LeOra Software, 1987). Mortalities were entered with corresponding weighed dose (mg/cm²) to take into consideration variability in the application rate.

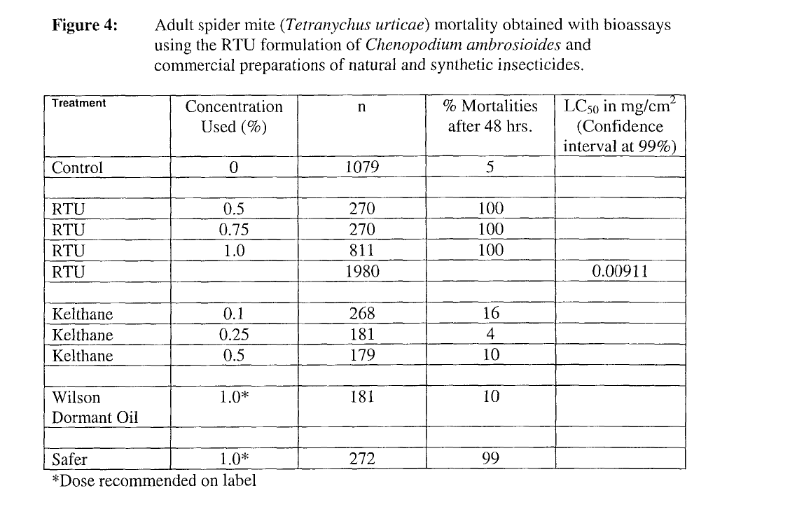

The results obtained with these bioassays are shown in FIG. 4.

Although the toxicity tests presented herein were performed with female mites, it will be clear to a person skilled in the art that those results show that the mortality that would have been observed for male mites would have been the same if not higher knowing that male mites are smaller than females.

### Example V

### Effect on the egg and nymphal stages of the spider mite (RTU formulation)

The RTU formulation was also tested on the egg and the nymphal stages of the spider mite. The ovicidal effect was determined with eggs of the twospotted spider mite following treatment with concentrations of the RTU formulation. Adult female T. urticae are transferred to 2 cm diameter leaf disks cut out of lima bean leaves and left for four hours for oviposition. When at least 20 eggs/disk are laid, adult mites are then removed. Leaf disks are moist and then sprayed and Petri dishes are weighed before and after treatment and stored after treatment. Egg hatch is assessed daily and for 10 days following treatment by counting the number of eggs remaining on the leaf disks and the number of live and dead nymphs present. Percent egg hatch is determined with live nymphs only. The nymphs are considered dead if no movement is observed after repeated gentle probing with a single-hair brush.

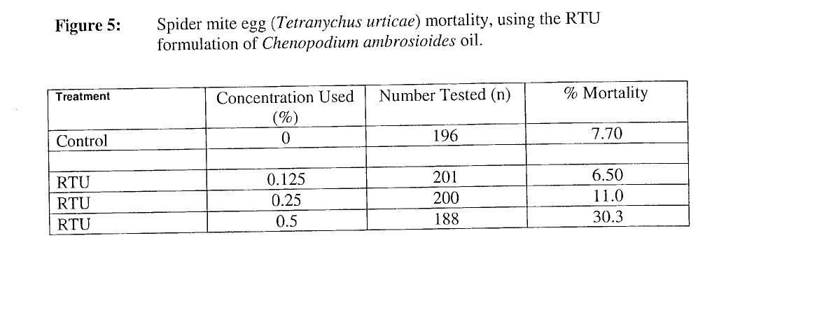

Results of the test on the egg stage (FIG. 5) indicate that the RTU formulation has some effect on the eggs with 30% mortality using a 0.5% solution of the oil. It is expected that a higher concentration of the oil should show greater efficacy on eggs.

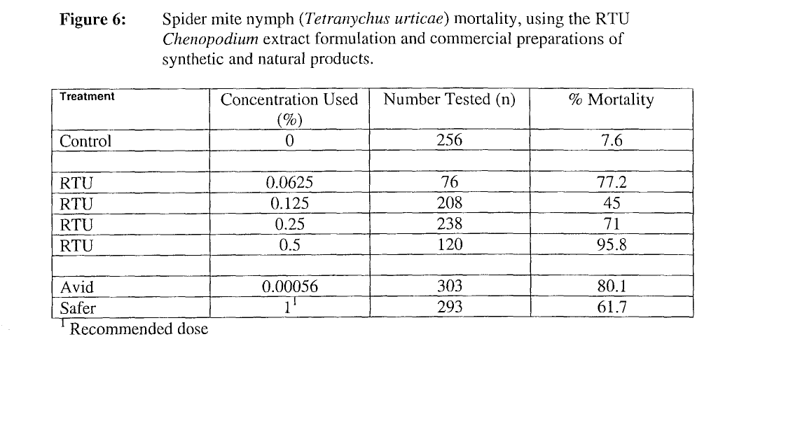

Similarly to the effect of the RTU formulation on the nymphal stage, even at the 0.5% concentration, the RTU gave higher results (95.8%) than the existing commercial preparations of either Avid (80.1%) or Safer Soap (61.7%) (FIG. 6).

### Example VI

### Residual effect of the RTU formulations of the present invention and comparison thereof with commercially available acaricidal products

The residual effect of the RTU formulation was also tested with the spider mite and compared to natural and synthetic products already on the market, (i.e. Kelthane™, Avid™, Safer's™ Soap and Wilson's dormant oil). The procedure for this test involved the preparation of vials containing a nutrient solution in which individual faba bean leaves were placed. Eighteen leaves were prepared for each concentration tested and each were sprayed with the indicated concentration until run-off lo and allowed to dry. Ten spider mites were placed on nine of the leaves one hour after spraying and ten were placed on the other nine leaves one day following treatment. Mortality was observed 24 and 48 hr following mite introduction on the leaves. The entire procedure was repeated three times.

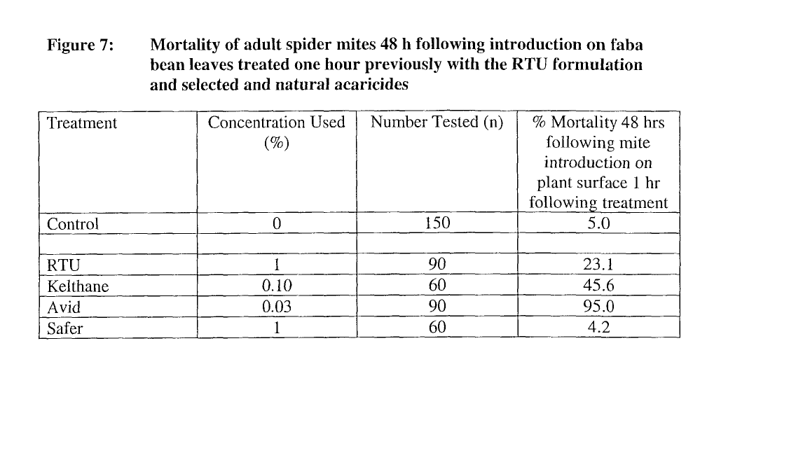

The results of the residual effect of the different products when the mite is introduced on the plant one hour following treatment are shown in FIG. 7. These results indicate that there is a residual effect of the RTU and that this effect is greater than in the Safer product. However, it is inferior to the residual effect of synthetic products such as Kelthane and Avid.

These results show the RTU formulation's very low persistence in the environment (about 23 mortality of spider mites when the pest is introduced on the plant one hour after treatment with the product). The RTU formulation is therefore compatible with the recommendations of the Integrated Pest Management program which supports control methods that do not harm natural enemy populations and permit rapid re-entry of workers to the tested area and uninterrupted periods of harvest while assuring safety to workers and consumers.

### Example VII

### Acaricidal activity of the extracts on other acari (RTU formulation)

To confirm the efficacy of the formulations of the present invention on plant infesting acari in general, certain bioassays were performed on another plant infesting mite, the European red mite, Panonychus ulmi, a mite which shows a close taxonomical relationship with T. Urticae.

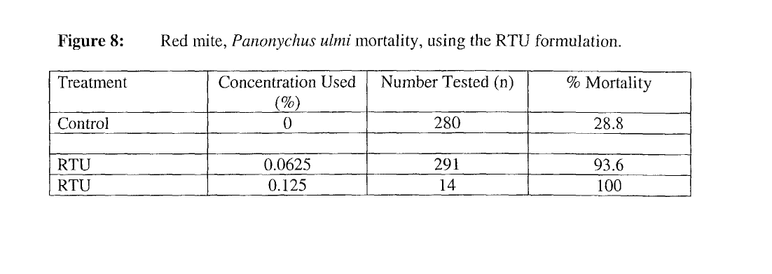

The RTU formulation was thus tested on the red mite Panonychus ulmi, a pest of apple orchards, following the same protocol described for contact efficacy on adult spider mites in order to confirm its broad effect as an acaricide. The results confirm the effectiveness of the essential oil extract as a contact acaricide (FIG. 8) which is not exclusively active on T. Urticae.

### Example VIII

### Insecticidal efficacy of the essential oil extract (RTU formulation)

Similar efficacy tests were also performed on several insect species that are serious pests of cultivated plants. The species tested were the greenhouse whitefly, Trialeurodes vaporariorum; the Western flower thrips, Frankliniella occidentalis; the green peach aphid, Myzus persicae; and the silverleaf whitfly, Bermisia argentifolii following the same protocol described in Example XI (C) below.

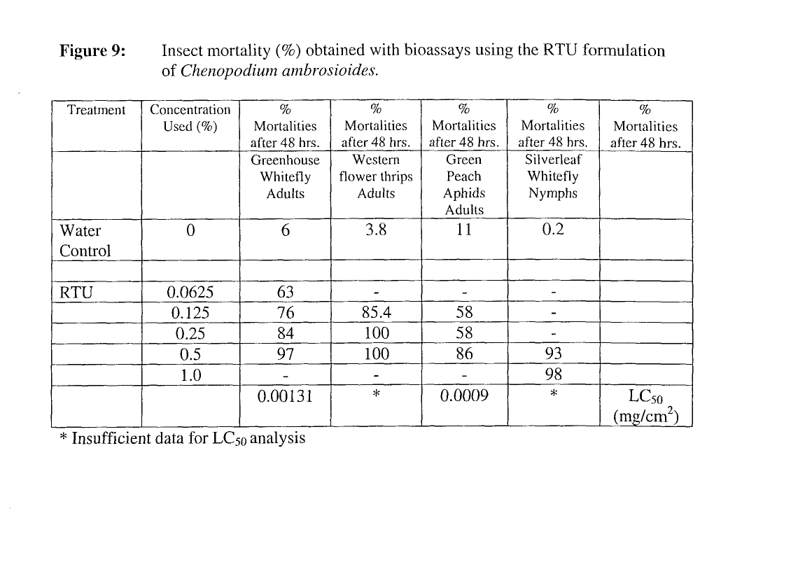

Results presented in FIG. 9 indicate that the RTU product is toxic to all organisms tested. LC₅₀ could be calculated for the greenhouse whitefly and the green peach aphid and results (LC₅₀ of 0.00131 mg/cm² and 0.0009 mg/cm² respectively) show that the product is as or more effective to these insects as the spider mite.

### Example IX

### Emulsifiable concentrate formulation

An emulsifiable concentrate formulation with an extract of Chenopodium ambrosioides was also prepared. The concentrate contains between 10 to 25% essential oil extract, emulsifiers, a spreader/sticker, and a carrier.

Examples of emulsifiable concentrate formulations are as follows.

| | Amount | Amount | Amount | Amount | Amount | Amount |
|---|---|---|---|---|---|---|
| Ingredient | (%) | (%) | (%) | (%) | (%) | (%) |
| Essential | 25 | 25 | 25 | 25 | 25 | 25 |
| oil extract | | | | | | |
| Rhodopex | 5 | 2.5 | — | — | 1.25 | — |
| CO-436 | | | | | | |
| Rhodopex | — | — | — | — | — | — |
| CO-433 | | | | | | |
| Igepal CO- | — | 2.5 | — | — | 1.25 | 2.5 |
| 430 | | | | | | |
| Igepal CA- | — | — | 5 | 2.5 | — | — |
| 630 | | | | | | |
| Igepal CO- | — | — | — | 2.5 | — | — |
| 887 | | | | | | |
| Isopropanol | — | — | 10 | — | — | — |
| Isopar M | — | — | 60 | 70 | — | — |
| Macol NP | — | — | — | — | — | 2.5 |
| 95 | | | | | | |
| THFA | 70 | 70 | — | — | 72.5 | 70 |

### Example X

### Acaricidal efficacy of the essential oil extract (Emulsifiable concentrate formulation)

Contact and residual bioassays were conducted in the laboratory to test the efficacy of the essential oil extract of the present invention. UDA-245, a 25% emulsifiable concentrate (EC) formulation of oil was tested against the adult and eggs of the twospotted spider mite and the European red mite.

The twospotted spider mite was reared on Lima bean plants (Phaseolus sp.) and the European red mite on apple leaves cv McIntosh (Malus domestica Borkhausen).

Contact efficacy with the adult stage

The methodology used for adults was the same for both species. Twospotted spider mite adults were treated with four concentrations of oil of a North American herbaceous plant (0.125, 0.25, 0.5 and 1.0% active ingredient (AI) UDA-245 EC25%; Urgel Delisle et Associés, Saint-Charles-sur-Richelieu, QC, Canada), neem oil (Neem Rose Defense® EC 90%; Green Light, San Antonio Tex., USA) at 0.7% AI, insecticidal soap (Safer's Trounce® EC 20% potassium salts of fatty acids with 0.2% pyrethrins; Safer Ltd. Scaborough, ON, Canada) at 1% AI and a water control. European red mite adults were treated with five concentrations (0.0312, 0.0625, 0.125, 0.25 and 0.5%) of UDA-245, abamectin (Avid® EC1.9%; Novartis, Greensboro, N.C., USA) at 0.006% AI and a water control.

Twenty-five mature female mites were deposited dorsally on a 1 cm² piece of double-coated tape glued on a glass microscope slide. For each treatment period, four slides were prepared for each treatment or acaricide application as defined above. Solutions for each treatment were prepared on the treatment day and each slide was sprayed at a pressure of 0.42 kg/cm² under an exhaust chamber with 250 μl of solution using a Badger 100-F® paint brush sprayer (Badger Air-Brush Co., Franklin Park, Ill., USA) mounted on a frame at a distance of 15 cm from the slide. The slides were weighed immediately before and after spraying to calculate the amount of active ingredient deposited per surface area (mg/cm²); this quantity varied less than 15% between slides. After spraying, the slides were placed on a styrofoam rack in a closed clear plastic container with a wet foam at the bottom to keep moisture high (90% R.H.). The container was stored in a growth chamber at 24° C. and 16L: 8D photoperiod. This experimental procedure was repeated on three consecutive days in a complete block design where treatment period was considered a block.

Mortality was assessed under a binocular microscope 48 (twospotted spider mite) and 24 hours (European red mite) following treatment. Because European red mite mortality in the control group at 48 hours was high, it was judged to be inadequate for statistical evaluation. Mites were considered dead if movement was imperceptible after repeated gentle probing with a single-hair brush. Data were transformed by arcsin√p and subjected to an ANOVA statistical analysis using SAS® software (SAS Institute, 1988). The LC₅₀ and LC₉₀ (in mg/cm² of AI) of UDA-245 were calculated with PROBIT analysis using POLO-PC® software (LeOra Software, 1987).

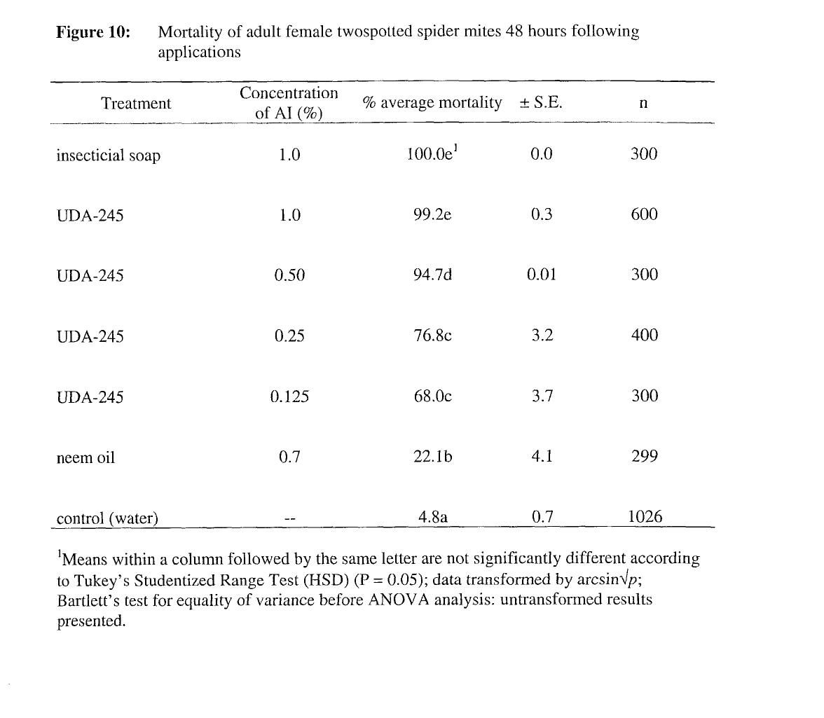

UDA-245 at 1% concentration and insecticial soap at 1% were most effective at controlling the adult twospotted spider mites causing 99.2 and 100% mortality respectively (FIG. 10). At 0.5, 0.25 and 0.125% UDA-245 resulted in 94.7, 76.8 and 68% mortality respectively. The least effective treatment was neem oil, which at the recommended dose caused only 22.1% mortality. The LC₅₀ and LC₉₀ of UDA-245 for the twospotted spider mite were 0.009 mg/cm² (99% confidence interval 0.0082-0.0099 mg/cm²) and 0.0292 mg/cm² (99% confidence interval 0.0268-0.0321 mg/cm²) respectively (significant at P=0.01). In comparison, the LC₅₀of insecticial soap had been determined by the manufacturer to be 0.016 mg/cm².

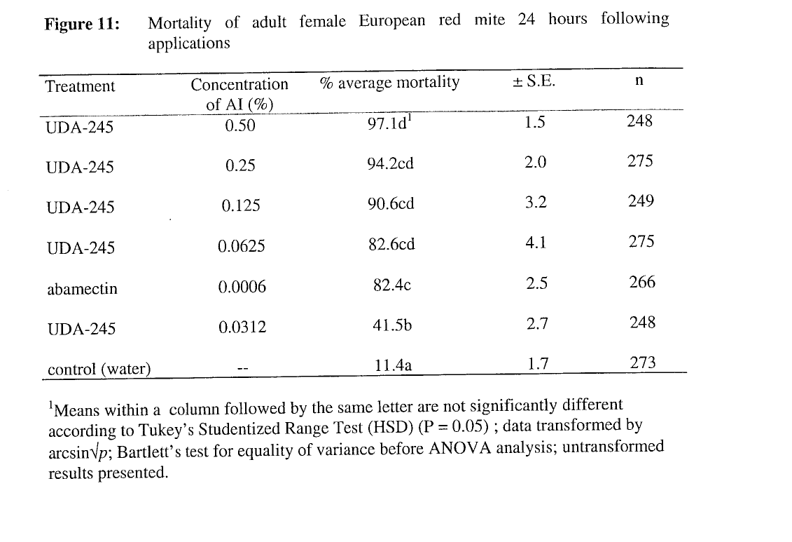

At 0.5% concentration, UDA-245 was significantly more toxic (97.1% mortality) to P. ulmi adults than abamectin (82.4%) (FIG. 11). Treatments with UDA-245 at concentrations ranging from 0.0625 to 0.25% gave statistically the same control level as abamectin. The LC₅₀ and LC₉₀ of UDA-245 for the red spider mite were 0.0029 mg/cm² (99% confidence interval 0.0019-0.0038 mg/cm²) and 0.014 mg/cm² (99% confidence interval 0.0108-0.0203 mg/cm²). UDA-245 gave <80% control of the adult stage of the two mites species at low doses.

Ovicidal activity

The ovicidal effect of the following products was determined with eggs of the twospotted spider mite and the European red mite: six concentrations of UDA-245 (0.0625, 0.125, 0.25, 0.5, 1 and 2%), neem oil at 0.7% AI, insecticidal soap at 1% AI and abamectin at 0.006% and a water control. Twenty adult female T. urticae were transferred to 2 cm diameter leaf disks cut out of lima bean leaves and left for four hours for oviposition. Female P. ulmi were left for 24 hours to lay their eggs on 2 cm diameter leaf disks of apple leaves. When at least 20 eggs/disk were laid, adult mites were then removed with a soft brush Leaf disks were kept on moist soft cotton swabs placed in small (4 cm diameter) plastic Petri dishes. Three leaf disks were prepared for each treatment or acaricide application. Leaf disks were sprayed and Petri dishes were weighed before treatment and stored after treatment as for the slides used in the bioassay with adults. This experimental procedure was repeated on three consecutive days in a complete block design where treatment period was considered a block.

Egg hatch was assessed daily and for 10 days following treatment by counting the number of eggs remaining on the leaf disks and the number of live and dead nymphs present. Percent egg hatch was determined with live nymphs only. The nymphs were considered dead if no movement was observed after repeated gentle probing with a single-hair brush. All nymphs (alive and dead) were removed daily from the leaf disks. Percent egg hatch (number of nymphs/total number of eggs on leaf disk X 100) were transformed with arcsin√ρ and subjected to an ANOVA statistical analysis using SASS software (SAS Institute, 1988).

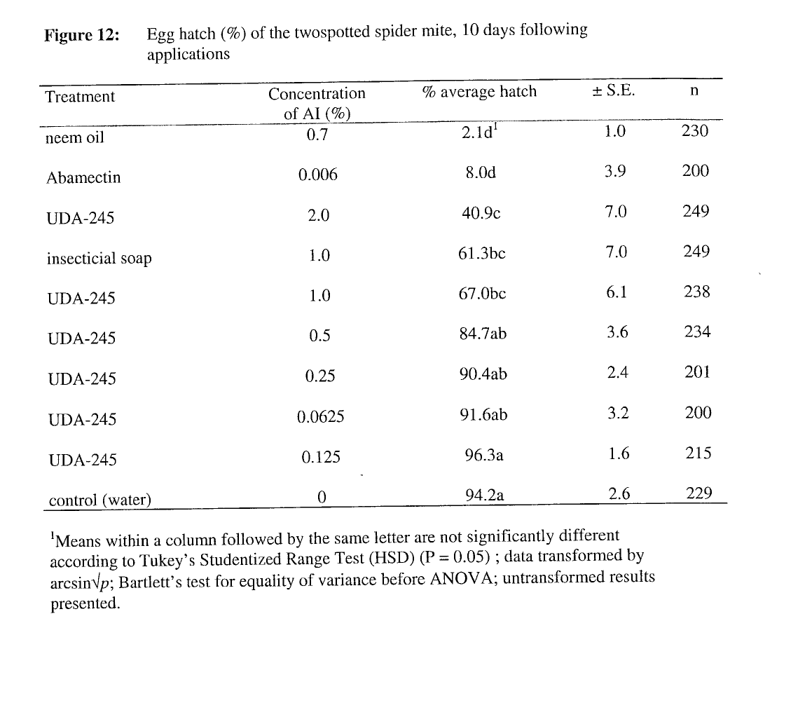

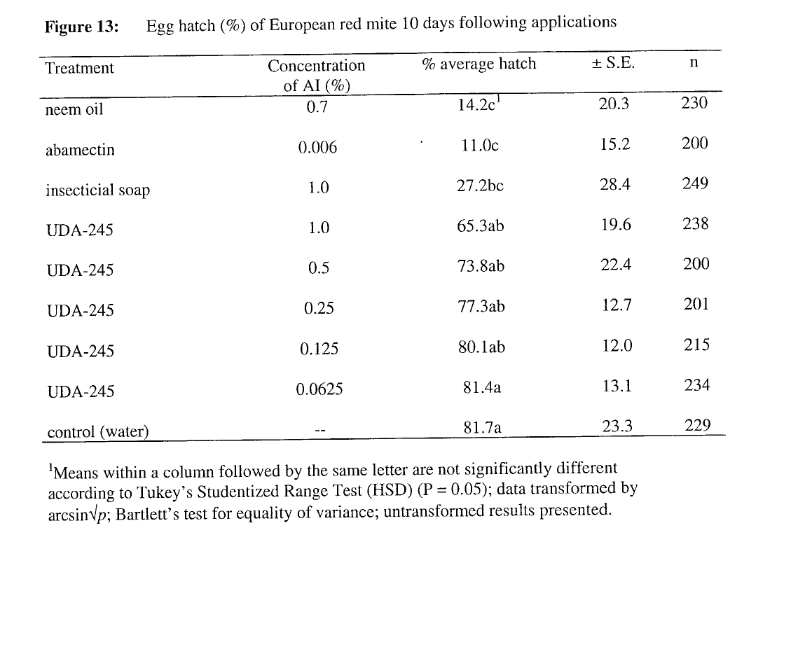

Egg hatch for the twospotted spider mite was significantly reduced by abamectin (8.0% egg hatch) and neem oil (2.1%) (FIG. 12). Egg hatch was reduced to 67 and 40% with 1.0 and 2.0% concentrations of UDA-245 respectively and to 61.3% with insecticial soap. Egg hatch for the European Red mite was significantly reduced compared to the control treatment with the recommended doses of insecticial soap (27.2% egg hatch), abamectin (11.0%) and neem oil (14.2%) (FIG. 13).

Residual bioassay with adult twospotted spider mites

Leaf discs measuring 2 cm in diameter of bean leaves were sprayed on both sides with a VEGA 2000 sprayer (Thayer & Chandler Co., Lake Bluff, Ill., USA) at 0.42 kg/cm² to runoff with 6.25 ml of each the following solutions: 2, 4, 8, and 16% of 99B-245, the recommended dose of dicofol (Kelthane® 35WP, Rohm and Haas Co., Philadelphia, Pa., USA) at 0.037% AI and a water control. Each treatment consisted of eight discs. One hour after treatment, 10 spider mites were transferred to each disc. Mortality was evaluated 48 hours following transfer of mites to the leaf discs. The procedure was repeated three times on three subsequent days.

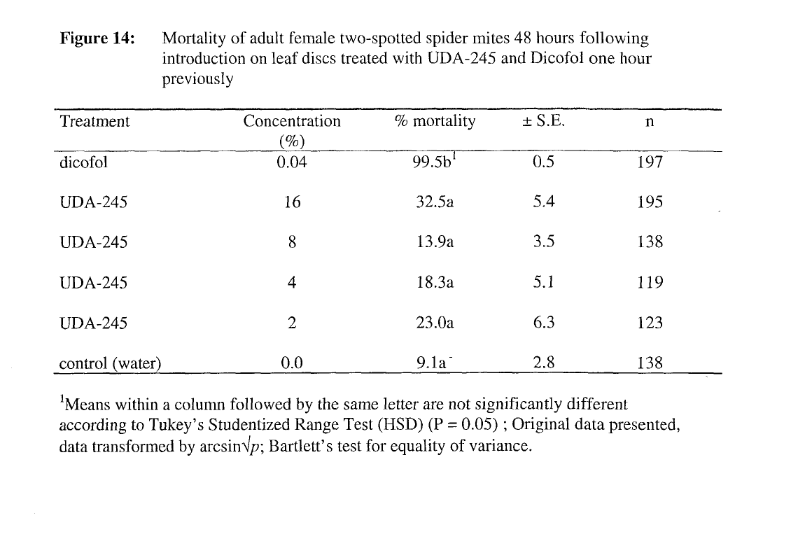

UDA-245 at 2, 4, 8 and 16% concentrations caused 23.0, 18.3, 13.9 and 32.5% mortality respectively to the adult spider mites when mites were introduced on bean leaves, 1 hr after treatment (FIG. 14). Dicofol's residual activity was significantly higher (99.5% mortality) than any of the UDA-245 concentrations.

UDA-245 was as effective as the insecticidal soap and synthetic acaricide abamectin to control adult twospotted spider mite and the European red mite. UDA-245 decreased egg hatch, but not as effectively as abamectin or neem oil. It may be important however to continue these investigations to determine the viability of emerged nymphs treated with the essential oil product because some botanicals, such as neem mixtures have shown growth-inhibiting properties to various pests (Rembald, 1989) and pulegone decreased larval growth of southern armyworm, Spodoptera eridania (Grunderson et al., 1985).

Furthermore we demonstrated that when adult mites are introduced one hour after treatment, the mortality rate was statistically comparable to that of the control (FIG. 14). A botanical such as UDA-245 may be an alternative to the more toxic or incompatible products. A contact acaricide with low residual activity can be used for treatments of localized infestations, before scheduled introductions of natural enemy populations or in absence of the natural enemy, i.e. treating at night in absence of diurnal parasitoids or predators.

Plant essential oils may be phytotoxic (Isman, 1999). The oil used for UDA-245 was evaluated on several edible and ornamental plants for its phytotoxic effects and results indicate that at the recommended dose, i.e. 0.5%, there were no observable effects on the leaves and flowers of tested plants (H. Chiasson, unpublished results).

### Example XI

### Insecticidal efficacy of the essential oil extract (Emulsifiable concentrate formulation)

Efficacy trials were conducted (laboratory and small-scale greenhouse trials) using the emulsifiable concentrate formulation of the present invention (lot no. UDA-245 at 25 % EC of chenopodium oil) with the following organisms: the green peach aphid (Myzus persicae), the Western flower thrips (Frankliniella occidentalis), the greenhouse whitefly (Trialeurodes vaporariorium) as well as the parasitoïa Encarsia formosa.

All bioassays were conducted in the laboratory of the Horticultural Research and Development Center (HRDC) of Agriculture and Agri-food Canada in Saint-Jean-sur-Richelieu, Quebec, Canada.

A. Contact bioassays in the laboratory and greenhouse using UDA-245 and commercially available bioinsecticides with the green peach aphid (Myzus persicae (Sulz.))

Laboratory bioassay

Five concentrations (0.125, 0.25, 0.5, 1 and 2 %) of formulation UDA-245 were compared to commercial preparations of Neem Rose Defense® at 0.5 % (EC 90 % hydrophobic Neem oil), Safer's Trounce at 1 % (EC 20 % with 0.2-% pyrethrin) and a water control. Each treatment was repeated 12 times and each replicate consisted of a 2 month old shoot (10-15 cm) of Verbena speciosa ‘Imagination’ placed in a plastic Aqua-Pick® (tube used by florist to keep stems of cut flowers wet) filled with 10 ml of water. Aqua Picks were secured on a block of Styrofoam placed on the bottom of a 11 transparent plastic container modified with screened sides and top to permit aeration. Green peach aphids (Myzus persicae (Sulz.)) were collected in plastic containers from a rearing cage maintained in a greenhouse colony. Ten adults were transferred to each Verbena shoot. The shoot was sprayed at 8 psi under an exhaust chamber for about 15 seconds (long enough to cover the whole shoot) with a VEGA 2000® paintbrush sprayer equipped with a 20 ml reservoir (Thayer & Chandler Co., Lake Bluff, Ill., USA). Each shoot and plastic container was then stored in a growth chamber at 24° C., 65% R.H. and 16L:8N photoperiod. The entire procedure was repeated four times.

Mortality was evaluated 48 hours following treatment by probing the aphid for movement with a small brush ; absence of movement was recorded as dead. To evaluate the relative efficacy of UDA-245, Neem Rose Defense® and Safer's Trounce®, percentage mortality data were transformed to arcsin√p and subjected to ANOVA analysis using SAS® software (SAS Institute 1988). LC₅₀ and LC90 were calculated using mortality results by PROBIT analysis using POLO-PC® software (LaOra Software 1987). Product concentrations (%) were used because data on quantity of active material deposited were not available.

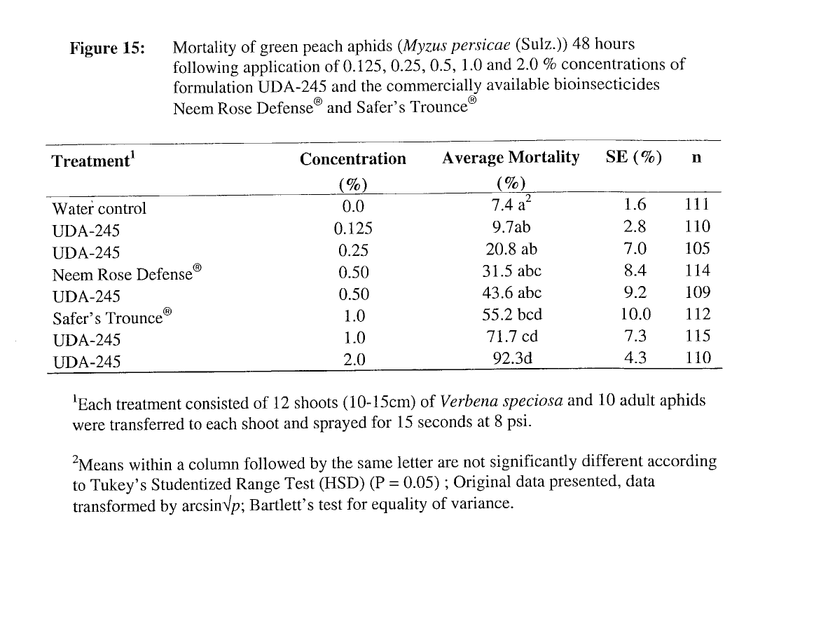

Results show that UDA-245 at 2.0% concentration was more effective (92.3% mortality) at controlling the green peach aphid than UDA-245 at 1% concentration (71.7%) and Safer's Trounce® (55.2%) though not significantly (FIG. 15 ). This lack of distinction between treatments may be due to the low number (n) of aphids tested. Treatments with UDA-245 at concentrations of 0.5% and less and with Neem Rose Defense® resulted in <50% mortality of the aphids and results were not significantly different to those obtained with the water control.

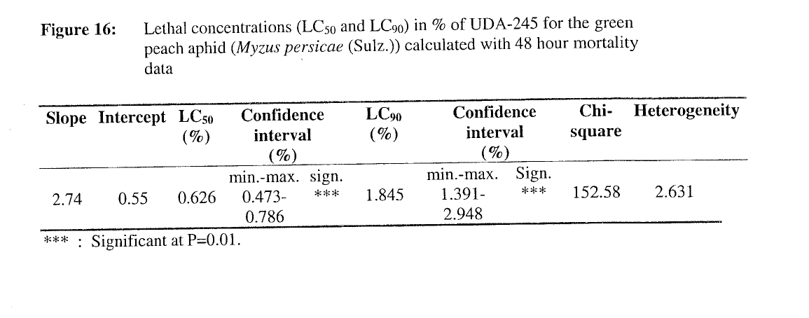

The LC₅₀ and LC₉₀ of UDA-245 for the green peach aphid was 0.63 (in % concentration) (Confidence Interval 0.47%-0.79 %) and 1.84 % (Confidence Interval of 1.39%-2.95%) respectively (FIG. 16).

Greenhouse bioassay

Three concentrations (0.25, 0.5 and 1%) of formulation UDA-245, Neem Rose Defense® at 0.5% (EC 90% hydrophobic Neem oil), Safer's Trounce® at 1% (EC 20% with 0.2% pyrethrin) and a water control were tested with the green peach aphid (Myzus persicae (Sulz.)). Fifteen plants (replicates) of two month old Verbena speciosa ‘Imagination’ (10-15 cm) grown in small plastic insertions cells (used for potting plants) filled with Pro-Mix BX® were used for each treatment. Each insertion cell was glued to the bottom of a 11 transparent plastic container with screened sides and top, to permit aeration. Green peach aphids were collected in plastic containers from a rearing cage maintained in a HRDC greenhouse and ten adults were transferred to each plant. The whole plant was sprayed for 15 seconds on average, at 8 psi under an exhaust chamber with a VEGA 2000® paintbrush sprayer equipped with a 20 ml reservoir (Thayer & Chandler Co., Lake Bluff, Ill., USA). Spraying was done three times over the course of the experiment, i.e. on days 0, 7 and 14. Containers with the sprayed plants were kept in a greenhouse under shade for the duration of the experiment.

Counts were done on days 7, 14 (prior to spraying) and on day 21 by dismantling five of the fifteen replicates in each treatment. Aphids were individually counted when numbers were small (<50). For larger numbers, plants were shaken over a clear 250 ml container filled with soapy water over a black and white grid to evaluate the number of aphids present. Plant leaf surface (cm²) was measured with an area meter LI-3100® (LI-COR Inc., Lincoln, Nebr., USA) and counts were averaged to number of aphids/cm² for each treatment and transformed to square root (x+0.5) for ANOVA analysis with SAS® software (SAS Institute, 1988) to evaluate the efficacy of the different treatments. Counts within treatments did not differ significantly (P=0.3647) from one sampling day to the other, so results within treatments were pooled and averaged for the whole experiment.

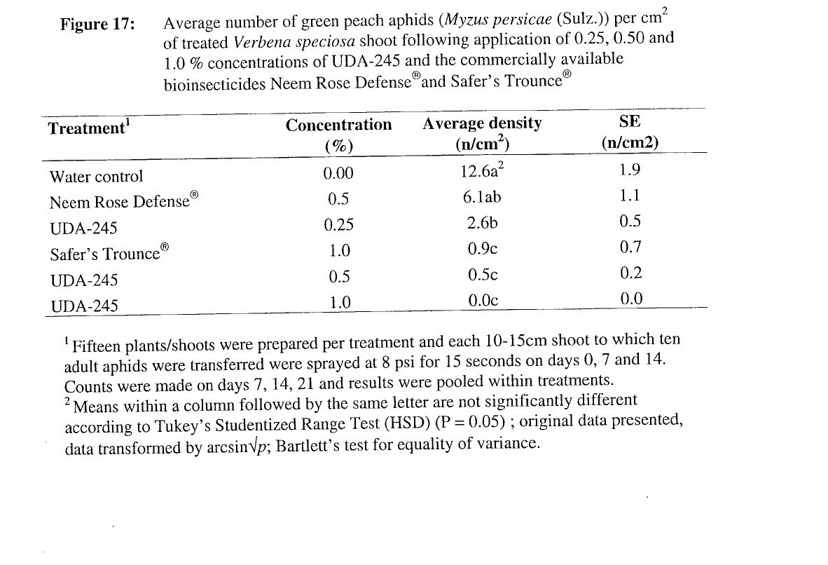

All concentrations of UDA-245 and Safer's Trounce® were more effective in controlling the aphids than the water control (FIG. 17 ). UDA-245 at 0.5% and 1.0% and Safer's Trounce were significantly more effective in reducing the number of aphids/cm² than Neem Rose Defense® and UDA-245 at 0.25%. Both 0.5% and 1.0% UDA-245 concentrations were more effective (0.5 aphids/cm² and 0.0 aphids/cm² respectively) than Safer's Trounce® (0.9 aphids/cm²) though not significantly.

B. Contact bioassays in the laboratory and greenhouse with the western flower thrips (Frankliniella occidentalis (Perg.)) using UDA-245formulation and two commercially available bioinsecticides.

Laboratory bioassay

Six concentrations (0.05, 0.18, 0.125, 0.25, 0.5 and 1%) of formulation UDA-245, Neem Rose Defense® at 0.7% (EC 90% hydrophobic Neem oil), Safer's Trounce® at 1% (EC 20% with 0.2% pyrethrin) and a water control were tested with the Western flower thrips (WFT : Frankliniella occidentalis (Perg.)). WFT were collected in plastic containers by tapping infested Lima bean leaves over white paper. Ten WFT (either adults or 3^{rd} or 4^{th} instar nymphs) were transferred to a closed 250 ml transparent plastic container. Wet dental cotton was inserted through the lid for use as a water source. Four replicates were prepared for each treatment. Containers were sprayed at 6 psi under an exhaust chamber for 15 seconds with a VEGA 2000® paintbrush sprayer equipped with a 20 ml reservoir (Thayer & Chandler Co., Lake Bluff, Ill., USA). Containers were weighed just before and after spraying to calculate the amount of active ingredient deposited in mg/cm². Containers were then stored in a growth chamber at 24° C., 65% R.H. and 16L: 8D photoperiod. The entire procedure was repeated four times.

Mortality was evaluated 24 hours following treatment under a binocular scope by probing WFT with a small brush. Absence of movement was recorded as dead. The efficacy of UDA-245 was compared to Neem Rose Defense® and Safer's Trounce® and data were transformed by arcsin√p and subjected to ANOVA analysis using SAS® software (SAS Institute 1988). The LC₅₀ and LC₉₀ (in mg/cm² of active ingredients) were calculated mortality results by PROBIT analysis using POLO-PC® software (LaOra Software 1987).

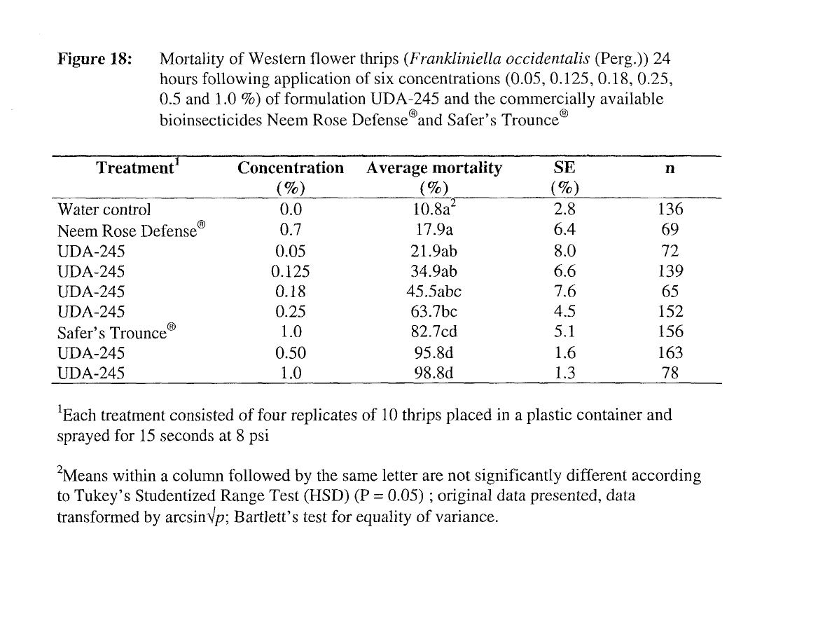

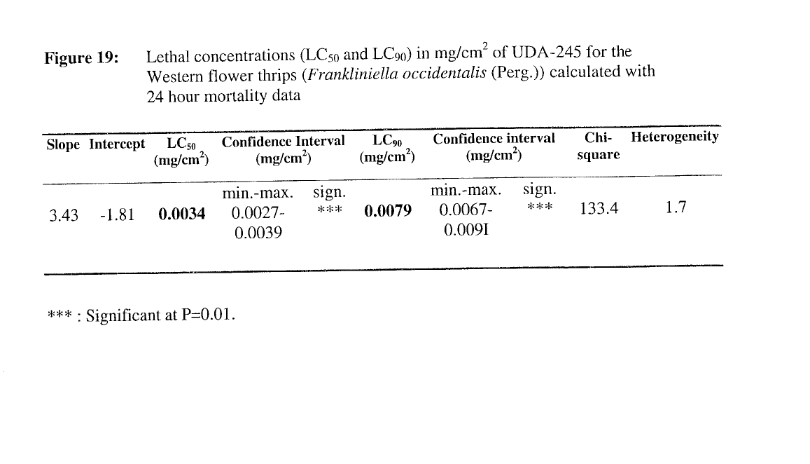

Formulation UDA-245 at 0.5% and 1.0% were significantly more effective (98.8% and 95.8% mortality respectively) in controlling the WFT than all other treatments except for Safer's Trounce® (82.7% mortality) (FIG. 18). UDA-245 at 0.25% caused significantly more mortality (63.7%) than the control (10.8%) but all remaining treatments did not. The LC₅₀ and LC₉₀ of UDA-245 for thrips was determined as 0.0034 mg/cm² (Confidence Interval: 0.0027-0.0039 mg/cm²) and 0.0079 mg/cm² (Confidence Interval: 0.0067-0.0099 mg/cm²) respectively (FIG. 19).

Greenhouse bioassay

Two concentrations (0.25% and 1%) of formulation UDA-245, Neem Rose Defense® at 0.7% (EC 90% hydrophobic Neem oil), Safer's Trounce® at 1% (EC 20% with 0.2% pyrethrin) and a water control were used to evaluate their relative efficacy in controlling the Western Flower thrips (WFT: Frankliniella occidentalis (Perg.)) in a greenhouse setting. Ten 10 day-old Lima bean plants (Phaseolus sp.) were prepared for each treatment. One leaf and the cotyledons of each plant were removed to keep only one leaf per plant grown in Pro-Mix BX® in a plastic insertion cell (used for potting plants) glued to the bottom of a clear plastic container (1) with screened sides and top. WFT were collected in small plastic containers by tapping infested bean leaves over white paper and lifted with a small brush. Ten adult thrips (or ₃rd or ₄th instar larvae) were transferred on each single leaf of each plant/insertion cell which were sprayed to drip point at 6 psi under an exhaust chamber with a VEGA 2000® paintbrush sprayer equipped with a 20 ml reservoir (Thayer & Chandler Co., Lake Bluff, Ill., USA). Spraying was done on days 0, 8 and 14. Each replicate/plastic container was then kept in a greenhouse under shade for the duration of the experiment.

Counts were made on days 8 and 14 (prior to spraying) and on days 21 and 28. All live stages present on the whole plant were counted under a binocular scope and the leaf surface was measured by comparing it to a series of pre-measured hand-made leaf-size patterns. On the last day of the experiment (day 28), the leaf was cut and its surface was measured with an area meter LI-3100® (LI-COR Inc., Lincoln, Nebr., USA). Counts were calculated as average number of thips/cm² per treatment. In order to compare treatments, average counts were then calculated as a percentage of thrips present on the control plants:

$$\frac{N \text{/} {cm}^{2} on treated plants}{N \text{/} {cm}^{2} on control plants} \times 100$$

The control treatment therefore had a value of zero and other treatments had positive or negative values indicating that more or less thrips were present respectively in relation to the control treatment.

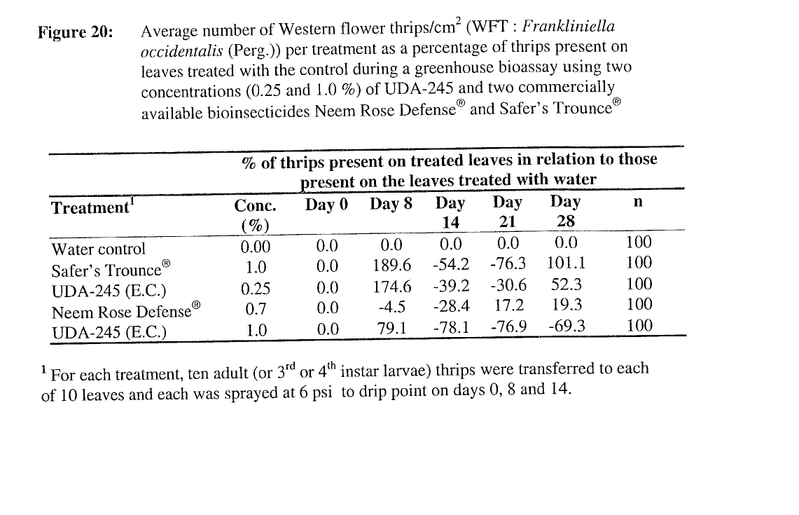

At the end of the experiment on day 28, leaves treated with UDA-245 at a concentration of 1.0% had 69.3% less WFT than leaves treated with the control while leaves treated with Safer's Trounce® had 101.1% more WFT (FIG. 20). Leaves treated with Neem Rose Defense® had slightly more thrips (19.3%) than the control on day 28. Leaves treated with UDA-245 at 0.25% concentration had 52.3% more thrips than the control on day 28.

C. Contact bioassay in the laboratory with the greenhouse whitefly (Trialeurodes vaporariorium (Westw.)) using UDA-245 and commercially available insecticides

Laboratory bioassay

Five concentrations (0.0625, 0.125, 0.25, 0.5 and 1%) of formulation UDA-245, Neem Rose Defense® at 0.7% (EC 90% hydrophobic Neem oil), Safer's Trounce® at 1.0% (EC 20% with 0.2% pyrethrin), Thiodan® at 0.044% (50 WP) and a water control were used to evaluate their relative efficacy in controlling the greenhouse whitefly (Trialeurodes vaporariorium (Westw.)). Whitefly adults were collected with an insect aspirator from HRDC greenhouses and glued to a black 5 cm ×7,5cm plastic card sprayed with Tangle-Trap® (Gempler's Co.) by emptying the aspirator over the card to obtain at least 20 adults per card. Cards were observed before spraying under the binocular scope to remove all dead and immobile whiteflies. Only active whiteflies were kept for the experiment. Four cards were used per treatment. Each card was sprayed at 6 psi with 300 μl of emulsion using a BADGER 100-F® (Omer DeSerres Co., Montréal, Canada) paintbrush sprayer mounted on a frame at a distance of 14.5 cm from the spray nozzle in an exhaust chamber. Cards were weighed immediately before and after spraying to calculate the amount of active ingredient deposited in mg/cm². Cards were allowed to dry under the exhaust chamber and then placed sideways on a Styrofoam rack in a closed clear plastic container of 5L with moistened foam on the bottom to keep humidity high (>90% R.H.). The plastic container was stored in a growth chamber at 24° C. and 16 L:8D photoperiod. This procedure was repeated three times.

Mortality was evaluated 20 hours following treatment by gently probing the whitefly with a single-hair brush under the binocular microscope. Absence of movement (antennae, leg, wing) following probing was recorded as dead. Relative efficacy of UDA-245 and the two commercially available bioinsecticides, Neem Rose Defense® and Safer's Trounce®, and the synthetic insecticide Thiodan®, were compared by transforming mortality data to arcsin√p and then subjecting to an ANOVA analysis using SAS® software (SAS Institute 1988). LC₅₀ and LC₉₀ (in mg/cm² of active ingredients) were calculated by PROBIT analysis using POLO-PC® software (LaOra Software 1987).

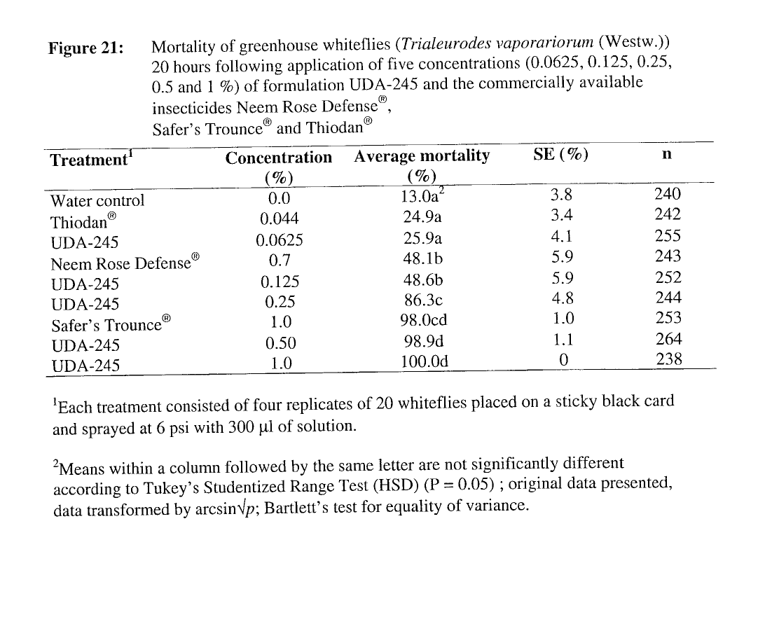

Formulation UDA-245 at concentrations 0.5% and 1.0% were significantly more effective (98.9% and 100.0% mortality respectively) at controlling the greenhouse whitefly than all other treatments except for Safer's Trounce® (98.0% mortality) (FIG. 21). Formulation UDA-245 at 0.125% concentration and Neem Rose Defense® were significantly more effective than the control treatment but significantly less effective than UDA-245 at 0.25, 0.5 and 1.0% concentrations and Safer's Trounce®. Thiodan and UDA-245 at 0.0625% concentration were as effective as the control treatment.

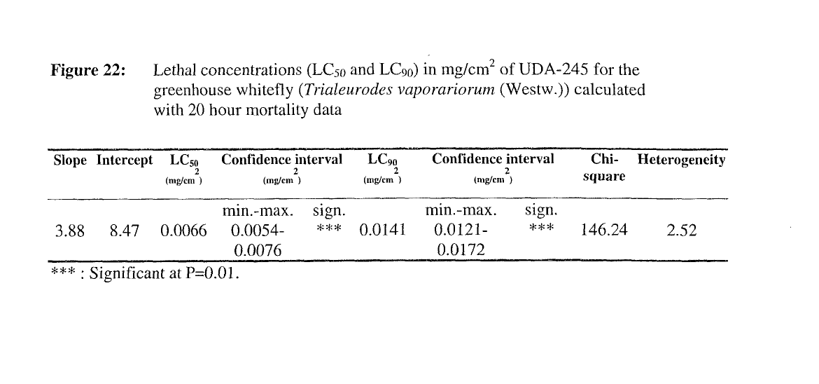

LC₅₀ and LC₉₀ were 0.0066 mg/cm² (conf. int:0.0054-0.0076 mg/cm²) and 0.014 mg/cm² (conf. int:0.0121-0.0172mg/cm²) respectively (FIG. 22).

D. Contact bioassay in the laboratory with the parasitoïd (Encarsia formosa) using UDA-245 and commercially available bioinsecticides

Laboratory bioassay

Four concentrations (0.0625, 0.125, 0.25 and 0.5%) of formulation UDA-245, Neem Rose Defense® at 0.7% (EC-90%), Safer's Trounce® at 1.0% (EC 20.2%) and a water control were tested with the parasitoïd Encarsia formosa (EF) (obtained from Koppert Co. Ltd). EF were kept in a growth chamber at 24° C., 16L :8N photoperiod and 65% R.H. until emergence. Sixty newly emerged adult EF were transferred with a mouth aspirator into plastic Solo® cups of 20 ml. Cups were sprayed at 6 psi under an exhaust chamber with 250 ml of solution with a Badger 100-F® paintbrush sprayer (Omer de Serre Co., Montréal, Canada) mounted on a frame at a fixed distance of 14.5 cm. Solon cups were weighed just before and after spraying to calculate the amount of active ingredient deposited in mg/cm². Once sprayed, the EF were gently transferred with a small brush from the Solo® cups to small clear plastic Petri dishes (10 EF/Petri) lined with a filter paper wetted with a 5% sugar solution as a food source. Four replicates were prepared for each treatment. The Petri dishes were then placed in a tray and stored in a growth chamber at 24° C, 65% R.H. and 16L: 8D photoperiod. The entire procedure was repeated three times.

Mortality was evaluated 24 hours following treatment under a binocular scope by observing the EF. Absence of movement was recorded as dead. The effect of UDA-245 was compared to Neem Rose Defense® and Safer's Trounce® using mortality data transformed by arcsin√p and subjected to ANOVA analysis using SAS® software (SAS Institute 1988).

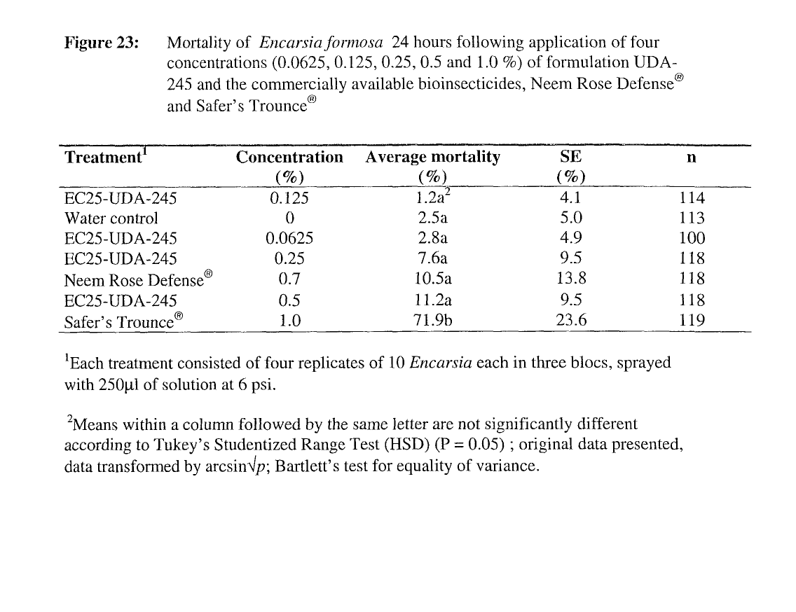

All UDA-245 formulations at concentrations ranging from 0.0625 to 0.5% were significantly less effective than Safer's Trounce® at 1% (71.9%) (FIG. 23). Results from all concentrations of UDA-245 and Neem Rose Defense® formulations were not significantly different than the control. These results indicate that the recommended dose (0.5%) of UDA-245 can be safely used with the biological control agent, Encarsia formosa.

### Example XII

### Effect of essential oil extract on beneficial pests

A. Direct toxicity of the essential oil extract on predatory mites Amblyseius fallacis and Phytoseiulus persimilis

The purpose of this study was to evaluate the direct toxicity of the UDA-245, a botanical biopesticide with two predaceous mites Amblyseius fallacis, a natural regulator of mites in integrated control orchards and Phytoseiulus persimilis, a known mite predator for the control of the twospotted mite in vegetable crops grown under glasshouses in Quebec and elsewhere. The suitability of UDA-245 as a primary tool in IPM of greenhouse crops would therefore be determined.

Rearing of Tetranychus urticae and Amblyseius fallacis

The phytophagous mite, Tetranychus urticae has been reared on common bean plants (Phaseolus vulgare) for several years at the Horticultural Research and Development Centre, St. Jean-sur-Richelieu, Quebec. The beans were sown at high densities of 40 to 50 plants per tray (39 cm ×30 cm). Colonies of T. urticae were kept in a growth chamber set at 25° C., 75% HR and 16 L photoperiod.

The predaceous mite Amblyseius fallacis was maintained on Tetranychus urticae and kept in a greenhouse set at 25° C., 75 HR and 16L photoperiod. A fan placed in front of the cage containing both Amblyseius fallacis and the twospotted spider mite provided continuous air flow to the colonies. Trays containing bean plants infested with the twospotted spider mites were added regularly to provide sufficient food to the predator colonies.

Rearing of Phytoseiulus persimilis

Colonies of Phytoseiulus persimilis were bought from Koppert Canada and reared in the laboratory in the same conditions as for A. fallacis. The colonies originating from the shipment were maintained and acclimatized in a growth chamber set at 25C, 70-85% RH and 16:8 (light/darkness) for two weeks.

Contact toxicity assay

The bioassays were carried out in Petri dishes using a leaf disc method. A wet sponge was placed in a plastic Petri dish (14 cm diameter and 1.5 high) and rings of apple leaf (cv. McIntosh; 3.5 cm of diameter) were cut and placed upside down on the surface of a water-saturated sponge. Sufficient numbers of all stages of the twospotted spider mite Tetranychus urticae Koch were then brushed onto each leaf disc. A total of five leaf discs were put in a Petri dish and each Petri dish represented one replicate. Ten replicates per treatment were prepared over a period of three weeks.

Gravid females of Amblyseius fallacies (5) or Phytoseiulus persimilis (9), were picked up at random under a stereormicroscope from leaves taken from plants used to rear the predator colonies. They were transferred individually with a fine camel brush to a small Petri dish (5.5 cm of diameter) containing a leaf piece of the common bean, Phaseolus vulgare. They were treated topically with 0.3 ml of pesticide solution at different dosages using a paintbrush sprayer (Vega 2000, Thayer & Chandler, Lake Bluff, Ill., USA) at 6 psi set at 14.5 cm above the treated area. The pesticide solutions were prepared on the day of application. Treated females were then transferred carefully and individually to each apple leaf disc. To avoid contamination, a new camel brush was used for each concentration to transfer the treated females to leaf discs. Petri dishes were put in a black tray and covered with transparent plastic covers and a strip of brown paper was placed on top to reduce glare and to keep the mites within the leaf disc area. Water was added to the tray to maintain high relative humidity. The trays were incubated in a growth chamber set at 25° C., 75% HR and 16 L Photoperiod. Mortality was recorded 24h and 48h after treatment. One and 2 replicates were set up per day respectively for A. fallacis and P. persimilis and only 11 treatments were evaluated for P. persimilis.

Treatments

UDA-245 is an EC formulation with 25% essential oil as an active ingredient. Seven concentrations of UDA-245 were prepared as follows. The 1% concentration was prepared by mixing 0.4 ml of the formulation and 9.6 ml of tap water and successive dilutions were made from the stock solution. The following commercially available insecticides were used at their recommended rates: Trounce® (20.2% of fatty acids and 0.2% pyrethrin) at the recommended concentration of 1%; the insect growth regulator Enstar® (s-kinoprene) at the concentration of 0.065%; and Avid® (abamectin 1.9%EC), at the concentrations of 0.0057% and 0.000855%. A water treatment was used as a control for a total of twelve treatments with A. fallacies and 11 with P. persimilis where the Enstar treatment was dropped.

The test product UDA-245 was sprayed first starting from the lower to the higher concentrations. Then the control treatment was applied followed the reference products Avid, Trounce and Enstar. The spray apparatus was rinsed three times between treatments using successively ethanol 95%, acetone, hexane, distilled water.

Statistical analysis

Mortality percentages were transformed to logit or probit to determine which analysis gave a better fit as recommended by Robertson and Preisler (1992). The analysis which presents the highest number of small individual Chi square (χ²) is chosen. Probit mortality were regressed on 1+log₁₀ (dose) for UDA-245. Concentration mortality regression lines were determined to estimate the lethal concentration to kill 50% of the predator population using the POLO-PC program (LeOra, 1987). Toxicity values of LC₅₀, LC₉₀ and LC₉₉ are given as percent (%) of active ingredient. Data were transformed to arcsine before analysis of variance. Comparison between treatments were analysed using GLM procedure and means were separated by the Fisher test at 5% probability (SAS, 1996).

RESULTS

Amblyseius fallacis

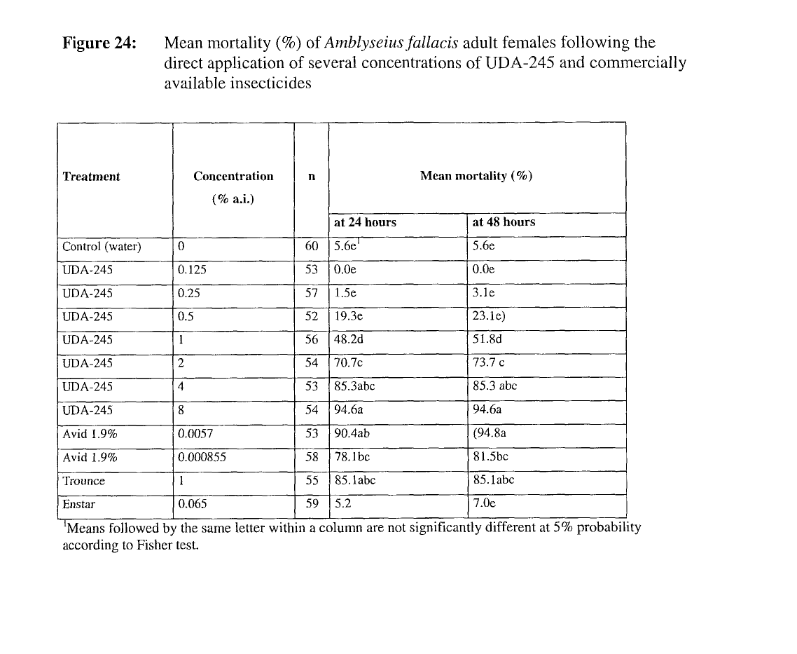

A total of 667 adult females of Amblyseius fallacis was tested and only 12 females (1.79%) walked out of the leaf disc area; number of missing was subtracted from initial total. Mortality in the control was 5.56% at 24 h and remained unchanged at 48 h following treatment (FIG. 24). There was a highly significant difference between treatments at 24 h (F=30.32, df=11, P<0.001) and at 48 h (F=31.64, df=11, P<0.001). There was no mortality after 48 h was with UDA-245 at the concentration of 0.125% and 3,1% 7% and 23% mortality with UDA-245 at 0.25%, Enstar and UDA-245 at 0.5% and these results were not significantly different from the control. Note that at the concentration of 0.5% the UDA-245 suggested commercial rate, mortality was 23.11% which is less than the 50% limit of the IOBC for harmless pesticides.

Amongst the commercially available products, Trounce caused the highest mortality (85.11%) after 48 H. This was followed by the Avid treatments at concentrations of 0.0057% (94.8% mortality) and 0.000855% (81.5% mortality) and results did not differ significantly, demonstrating that both products are equally toxic to Amblyseius fallacis.

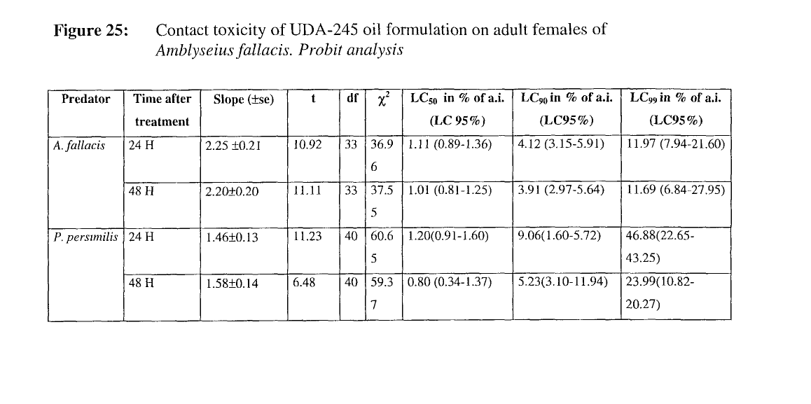

LC₅₀, LC₉₀ and LC₉₉ values at 48 h (FIG. 25) are well above (1.01%, 3.91% and 4.12% respectively) the 0.5% effective dose used to control the spider mite pest, Tetranychus urticae)(Chiasson, unpublished results).

These results indicate that UDA-245 might have low or no residual toxicity to Amblyseius fallacis and most adult females that remained alive 24 hours after the UDA-245 treatments continued to reproduce and were observed laying eggs.

Phytoseiulus persimilis

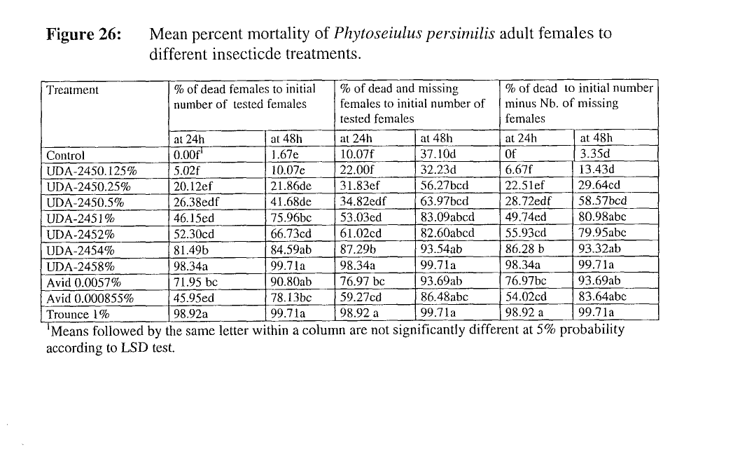

A cohort of 555 adult females was used to evaluate the toxicity of UDA-245 and the commercially available Trounce and Avid with the mite predator, Phytoseiulus persimilis. In this bioassay, 7.35% and 13.17% of the total number of gravid females escaped from the leaf disc 24 h and 48 h respectively after treatments. They contributed to 13.06% and 18.35% of the total mortality recorded at 24 h and 48 h respectively. The highest number of predator escapees were observed in the control treatment and in the UDA-245 treatments at concentrations lower than 2%. We will discuss only mortality calculated over total number treated minus missing individuals (3^{rd} column of FIG. 26).

Highest mortality were caused by Trounce (99,71%) followed by Avid at the concentration of 0.0057% (93.69%).The lowest mortality was observed in the treatment with UDA-245 at the 0.125% concentration (13.43%). Mortality with UDA-245 at 0.125%, 0.25 and 0.5% were not significantly different from the control treatment.

When missing females were deducted from the initial number of adults tested, the LC₅₀ of P. persimilis was 1.2% and 0.8% at 24 h and 48 h after treatments respectively (FIG. 25).

B. Direct toxicity of the essential oil extract on aphid endoparasitoids Aphidius colemani (Hymenoptera: Brachonidae, Aphidiinae)

In the present study, adult Aphidius colemani wasps were exposed to a direct spray application of UDA-245 and remained in permanent contact with the biopesticide residues, which is considered worse case conditions, to test the potential side effects this biopesticide may have on beneficial hymenoptera such as Aphidius colemani

Rearing of Aphidius colemani

Aphidius colemani wasps were purchased from Plant Product Quebec in lots of 250 mixed mummies and adults. The emerged wasps and the remaining mummies were directly transferred to a 5 litre plastic bag filled with air and the wasps were provided with a 10% solution of sucrose and honey (w/w) as food source and water.

Direct contact bioassay

Six to 14 adult parasitoids less than 48 h old were transferred into a large solo cup (500 ml ca.) using a mouth aspirator. The solo cup was lined with a filter paper (Rothmans #1) and had two large openings drilled on the side and one on the cover to provide ventilation and these openings were covered with a fine screen to prevent escape of adult wasps and condensation of the pesticide vapour. The filter paper was humidified with a 10% solution of sucrose and honey. The solo cup containing the wasps was weighed and the wasps were dragged down to the bottom of the solo cup by means of successive beats on the cover with a 15 cm long stick. They were treated with 0.3 ml of the insecticide solution using a paintbrush sprayer (Vega 2000, Thayer & Chandler, Lake Bluff, Ill., USA) at 6 psi and set at 14.5 cm above the treated area. The solo cup was then covered and re-weighed to determine weight of pesticide used. The treated wasps were then incubated in a growth chamber set at 18° C.-22° C. and 60-65% HR. Assessment of treatment effects were made at 24 h and 48 h following treatment.

Residual bioassay

Ten to 20 adult wasps including at least 5 females were picked up and put in a glass Petri dish and covered. The cover had an opening covered with a screen to enable ventilation and to prevent condensation of the pesticide vapour. The Petri dishes were previously treated with a pesticide solution exactly in the same manner as for direct toxicity bioassay but dishes were left to dry for an hour before covering and exposing the wasps to the pesticide residues. On the cover, two small circular holes were drilled and used to provide the wasps with water and a solution of honey and sucrose. Mortality was recorded at 24 h and 48 h.

Treatments

The test product isUDA-245, an 25% essential oil EC formulation obtained from Codena Inc. Seven concentrations were prepared as follows: UDA-245 at 8% was prepared by mixing 3.2 ml of UDA-245 and 6.4 ml of tap water and successive dilutions of 4%, 2%, 1%, 0.5% and 0.125% were made from the stock solution. Commercially available insecticides were used at their respective recommended doses as positive controls: Trounce® (20.2% of fatty acids, Safer Ltd, Scarborough, Ont.) at the recommended concentration of 1%, the insect growth regulator Enstar® (s-kinoprene) at the concentration of 0.065%; Avid® (abamectin 1.9% EC) at the concentrations of 0.0057% and 0.000855%, and Thiodan® (endosulfan 50 WP) at the concentration of 5%.

The test product UDA-245 was used first, starting from the lowest to the highest concentration and followed by the water control and finally by Avid, Trounce, Enstar and Thiodan. The spray apparatus was rinsed three times between treatments using successively ethanol 95%, acetone, hexane, distilled water.

Statistical analysis

Concentration was analysed as main effect and the weight of pesticide applied was tested as a covariate to correct for difference in quantity of applied pesticide. This covariate was deleted from the model when found not significant. Mortality regression lines were determined to estimate the lethal concentration to kill 10%, 50% and 90% of the parasitoid population using the POLO-PC program (LeOra, 1987). Toxicity values of LC₅₀ are given as percent of active ingredient. Data were transformed to arcsine before analysis of variance but actual means were presented. Comparison between treatments were analysed using GLM procedure and means were separated by Fisher test at 5% probability (SAS, 1996).

Effect of treatments on Aphidius colemani emergence from mummies

Myzus persicae mummies parasitized by Aphidius colemani females on leaves of cabbage (cv. Lennox) were used in this test. Portions of leaves bearing mummies were cut and placed in a Petri dish. The Petri dish was weighted and treated with a pesticide solution and immediately re-weighted to determine the amount of pesticide used. The treated Petri dish was then covered and sealed with parafilm. The cover of the Petri had a screened opening to enable ventilation and to prevent escape of emerging Aphidius adults. The incubation period lasted 7 days and all mummies that did not emergence as adult wasps were considered dead.

Fecundity assessment

Females that survived the pesticide residual treatments were assessed for fecundity on wheat plants infested with aphids. Myzus persicae aphids reared on cabbage plants (c.v. Lennox) were brushed onto a pot containing 25 to 30 plants of wheat 6 days old. Soon after, the brushed aphids climbed the wheat plants and a density of at least 100 aphids per pot was required. Female wasps that survived the 48 h residual treatments were removed individually from the test arena by means of an aspirator and confined over pots of aphid-infested plants using ventilated transparent plastic cylinders for a period of 24 h. The females were then removed and the plant bearing parasitized aphids were incubated for a period of 10 days at 18° C. to 22° C. At the end of the incubation period, the wheat plant was cut and put in a Petri dish. The number of parasitized aphids were counted.

RESULTS

Direct contact bioassay

A total of 1174 adult wasps including 657 or 55.9% female parasitoids were tested in the bioassay. The mean quantity of pesticide solutions applied was 4.58±1.36 mg/cm² which was more than double the amount of 2.0±0.2mg/cm² recommended for the typical bioassay (Mead-Briggs et al., 2000).

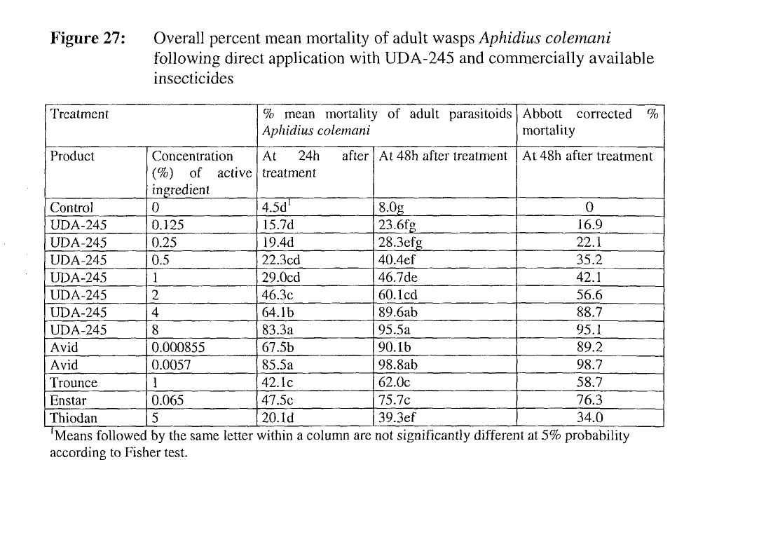

Mortality with UDA-245 at concentrations up to 1% was not significantly different than for the water control after 24 h. though at 48 h, results with UDA-245 treatments at the 0.5% and 1% concentrations significantly different from the control (FIG. 27). At the 0.5% concentration of UDA-245, recommended for field application, mortality varied from 18.6% to 35.2% at 24 h and 48H after treatments respectively. Highest mortality was observed with the Avid treatments at concentrations of 0.0057% and 0.000855% and with the UDA-245 treatment at concentrations of 4% and 8%.

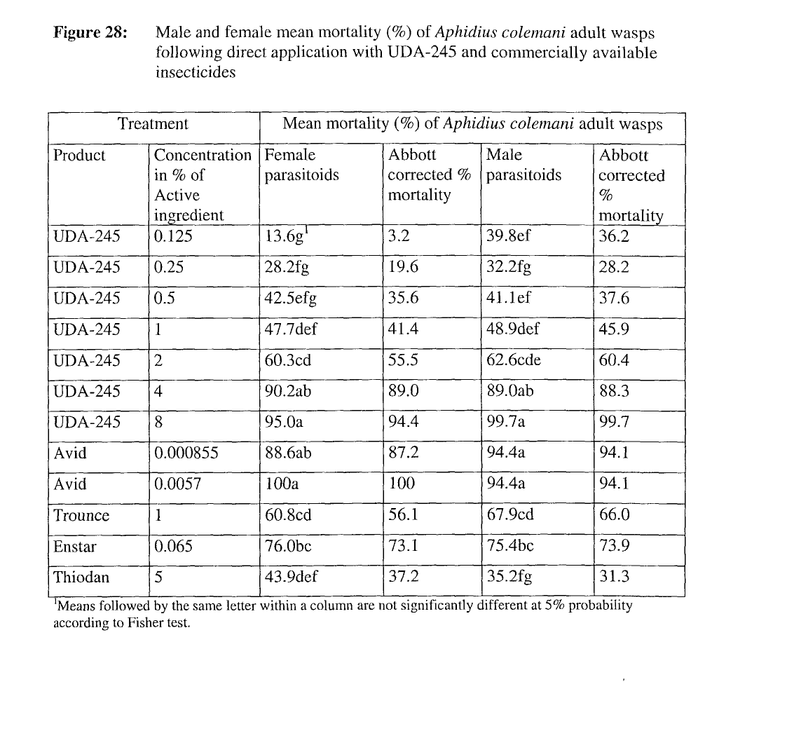

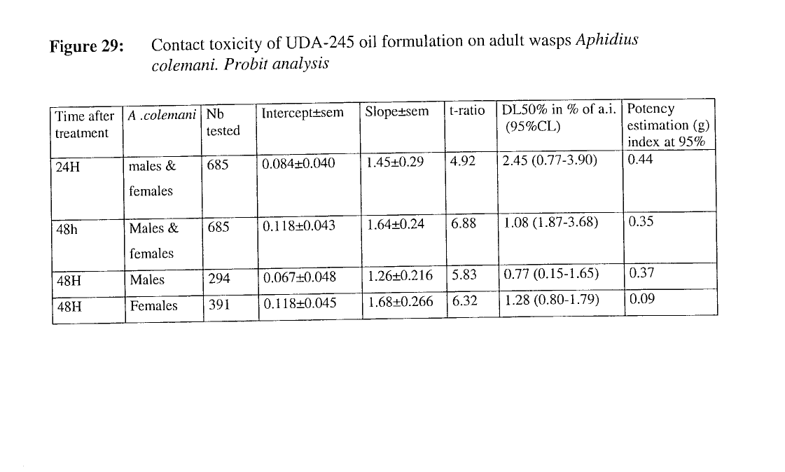

Results in FIG. 28 show that female wasps were relatively less sensitive to treatments than adult males. LC₅₀ values for UDA-245 on A. colemani females (FIG. 29) was equal to 1.28% which is more than twice the recommended concentration of 0.5% for field application. The LC₅₀ for A. colemani males was lower at 0.77% but still above the 0.5% field recommended concentration of UDA-245. However, the 95% confidence limits (CL 95%) of LD50% for both males and females were overlapping and therefore their LD50% were not differently significant (Robertson and Presisler, 1992).

Residual assay

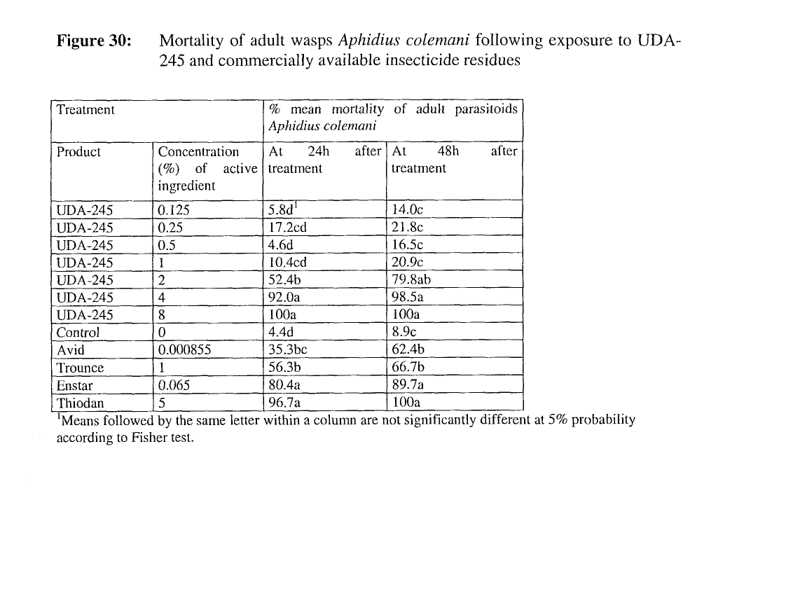

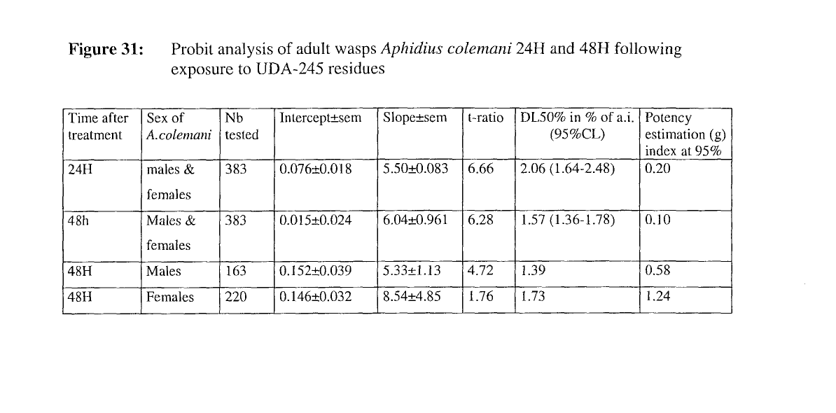

Results shown in FIGS. 30 and 31.

Effect of treatments on Aphidius colemani emergence from treated mummies

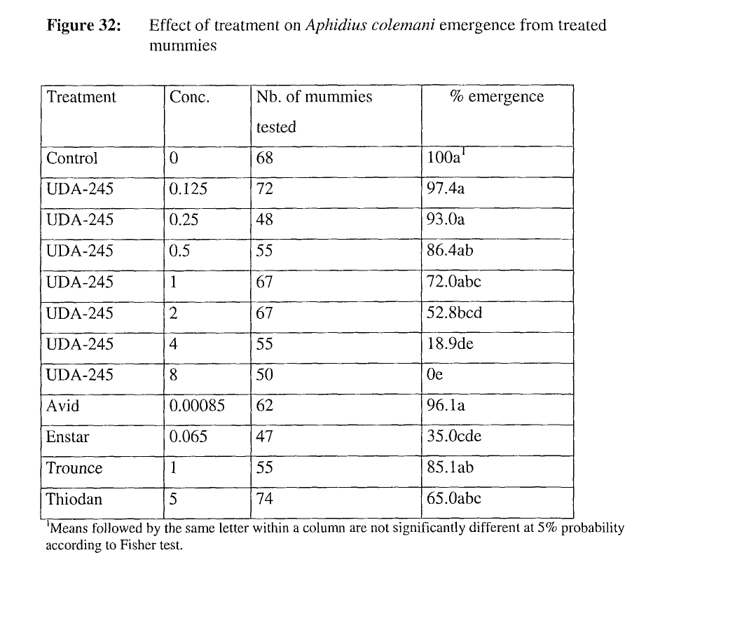

FIG. 32 showed that the effects of treatments on emergence of Aphidius colemani adults from treated mummies were significant (F=6.94,dl=16, P<0.0001). The emergence rate of A. colemani decreased steadily when UDA-245 concentration increased and there was no emergence at the concentration of 8%. At the recommended concentration for field application, i.e. 0.5%, emergence was 86.4% and this result was not statistically different from that observed in the control. In the reference products tested, the highest emergence was observed in the Avid treatment with 96.1% and the lowest was Enstar at 35% emergence.

Fecundity assessment

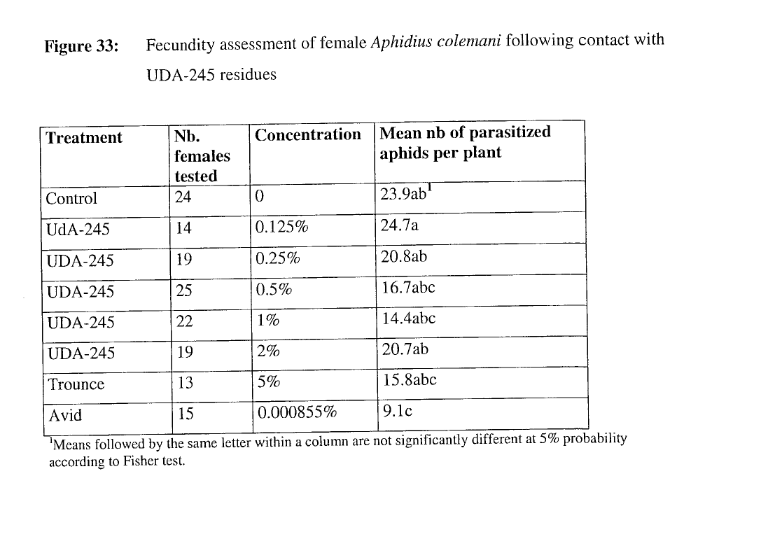

The results of FIG. 33 indicated that females that survived the treatment were able to parasitize Myzus persicae hosts and that their reproductive functions did not seem to be affected. There was no enough surviving female to test for the UDA-245 concentration of 4% and 8%. The lowest fecundity rate was observed in the treatment of Avid with 9.1 mummies per plants compared to 23.9 mummies per plant recorded in the control treatment. The number of mummies produced from females treated with UDA-245 treatments at concentrations varying from 0.125 to 2% were not significantly different from the control.

C. Direct toxicity of the essential oil extract on predatory minute bug Orius insidiosus Say

Various Orius species including Orius insidiosus Say (Heteroptera: Anthocoridae) are effective biological control agents of western flower thrips (WFT) Frankliniella occidentallis Pergrande (Thysanoptera:Thripidae) in sweet pepper, cucumber and other vegetable and ornamental crops (Veire de van et al., 1996).

The present study was initiated to evaluate the side effects of UDA-245 on the predatory bug Orius insidiosus under laboratory conditions.

Culture of Orius insidiosus

Orius insidiosus stock culture was initiated with individuals obtained from a commercial supplier (Plant Prod Quebec, 3370 Le Corbusier, Laval, Quebec) and maintained in a laboratory growth chamber. Eggs of Ephestia spp were served as a food source and snaps beans of Phaseolus vulgaris as an oviposition substrate. The beans containing eggs were then incubated in folded brown paper until emergence. The folded paper was used to reduce cannibalism. Emerging nymphs were then transferred into one litre jars containing bean pods and fed with Ephestia eggs until the adult stage. The stock culture was renewed regularly.

Direct contact bioassay

The bioassays were carried out in small Petri dishes (5.5 cm in dia.) using a leaf disc method. A thin layer of agar 2% (2-3 mm) was poured into each Petri dish and a ring of apple leaf (cv. McIntosh, 3.5 cm in dia.) was cut and placed upside down on the surface of the agar. At least 10 Orius insidiosus 2^{nd} nymph instar or adults were transferred carefully using an aspirator on the surface of the apple leaf disc. The Petri dish containing the nymphs or the adults bugs were dragged down to the bottom of the Petri dish by means of successive beats on the cover with a 15 cm long stick. The Petri dishes were weighted and immediately, they were treated immediately with 0.3 ml of pesticide solution at different concentrations using a paintbrush sprayer (Vega 2000, Thayer & chandler, Lake Bluff, Ill., USA) at 6 psi and set at 14.5 cm above the treated area. The Petri dishes were then re-weighted to determine the quantity of pesticide applied. The pesticide solutions were prepared on the day of treatment. The treated nymphs or adults were then transferred carefully to the surface of the apple leaf disc containing eggs of Ephestia spp-as a source of food. To avoid contamination, a new camel brush is used for each concentration to transfer the treated nymphs or adults to the leaf discs. The Petri dishes were put in a tray and incubated in a growth chamber set at 25° C., 65% HR and 16 L Photoperiod. A fan was placed in front of the tray to provide continuous air flow. Mortality of nymphs was recorded at 1, 2, 5, 7 and 9 days after treatment when more than 80% of the nymphs became adults. Mortality of adult predators was recorded at 24H and 48H following treatment. Ten replicates were prepared per treatment and 12 treatments were evaluated on second instar nymphs and adults.

Treatments

The test product is a UDA-245, a 25% EC essential oil formulation obtained from Codena Inc. Seven concentrations were prepared as follow: UDA-245 at 8% was prepared by mixing 3.2 ml of UDA-245 and 6.4 ml of tap water and successive dilutions of 4%, 2%, 1%, 0.5% and 0.125% were made from the stock solution. UDA 245 was compared to the recommended doses of the following commercially available insecticides:Trounce® (20.2% potassium salts of fatty acids and 0.2% pyrethrins) at the recommended concentration of 1% ; the insect growth regulator Enstar® (S-kinoprene), at the recommended concentration of 0.065% and Avid® (abamectin 1.9% EC) at the concentration of 0.000855%, Thiodan® (endosulfan 50 WP) at the concentration of 5% and Cygon® (dimethoate) at the concentration of 4%. Water was used as a negative control.

The test product UDA-245 was sprayed first, starting from the lowest to the highest concentration followed by the water control treatment and finally by the reference products Avid, Cygon, Enstar, Thiodan and Trounce. The sprayer was rinsed three times between treatments using successively ethanol 95%, acetone, hexane and distilled water.

Fecundity assessment

The potential sublethal effects of UDA-245 on Orius insidiosus female fecundity was monitored. Fecundity assessment was carried out on females that survived 48 h after the direct contact pesticide treatments. Surviving females were separated from males and put individually in a Petri dish filled with a 2 mm layer of agar used as a support and an apple ring (5.5 cm) placed upside down on the agar surface along with a 3 cm long pod of faba bean (Phaseolus vulgare). The apple leaf disc and the bean pod were used as oviposition substrates. The Petri dish was covered with the correspondent cover and sealed with parafilm. The Petri cover had an opening covered with fine muslin tissue for ventilation and air exchange. Females were left undisturbed for 48H for oviposion and then were fed with sufficient numbers of Ephestia spp eggs. After the 48 h period, females were then transferred to another Petri dish for a second 48H oviposition test. During both periods, the eggs laid were counted and left to hatch for 5 days. The eggs that do not hatch after 5 days were considered dead and not viable.

Statistical analysis

LC₅₀ values of UDA-245 were determined using probit analysis with POLO software (LeOra, 1987). Concentrations were analysed as main effects and the weight of pesticide applied was tested as a covariance to correct for difference in quantity of the applied pesticide. This covariance was deleted from the model when found not significant. Mortalities were analysed using General Linear model (GLM) procedure within SAS (SAS, 1996) and the number of individuals initially introduced were tested as a covariant. Means were adjusted for covariance when appropriate and separated using the Fisher test for means comparison. However, actual means were presented in the results section.

RESULTS

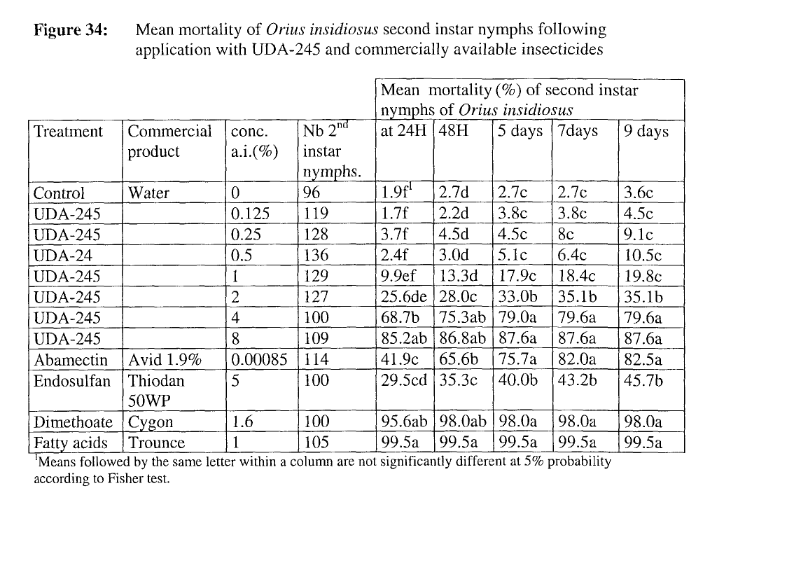

Results show (FIG. 34) that nine days following treatment application, with Onus nymphs, the most toxic treatments were in decreasing order, Trounce (99,5% mortality), Cygon (98% mortality), UDA-245 at 8% concentration (87.6% mortality), Avid (82.5% mortality) and UDA 245 at 4% concentration (79.6% mortality). All results were significantly different from that of the control treatment (3.6% mortality). Less than 50% mortality was obtained with the other treatments though only Thiodan (45.7%) and UDA-245 (35.1%) results were significantly different from the control.. Results with UDA-245 at the recommended concentration for field application of 0.5% were not significantly different from results obtained with the control.

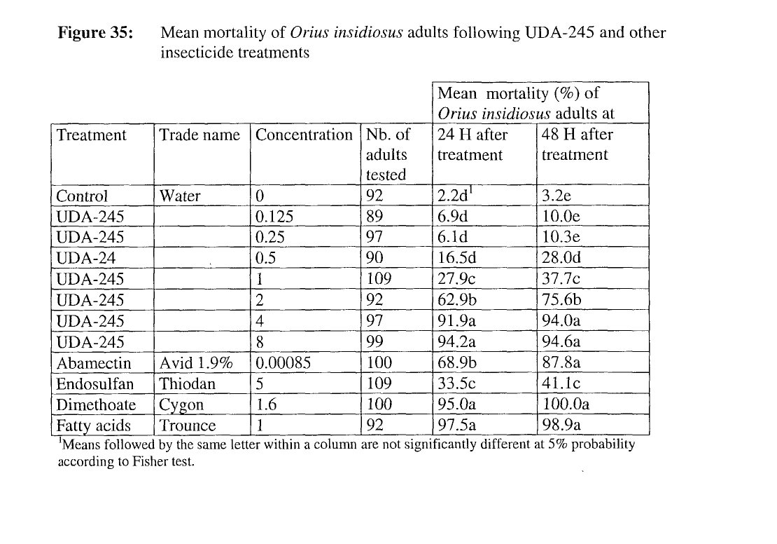

Results show (FIG. 35) that the effects of the 12 treatments expressed as percent mortality of adults was significantly different at 24H after treatment (F=55.9, df=11, p<0.0001) and at 48H after treatment (F=63.2, df=11, p<0.0001). The least toxic treatments of UDA-245 at concentration of 0.125% and 0.25% were not statistically different from the control treatment. The treatment of UDA-245 at the recommended field concentration of 0.5% was the least toxic of the remaining treatments causing a mortality of 28%. The most toxic group included Cygon (100% mortality), Trounce (98.9% mortality), UDA-245 at concentrations of 4 and 8% (94% and 94% respectively) and Avid (87.8%).

Fecundity assessment

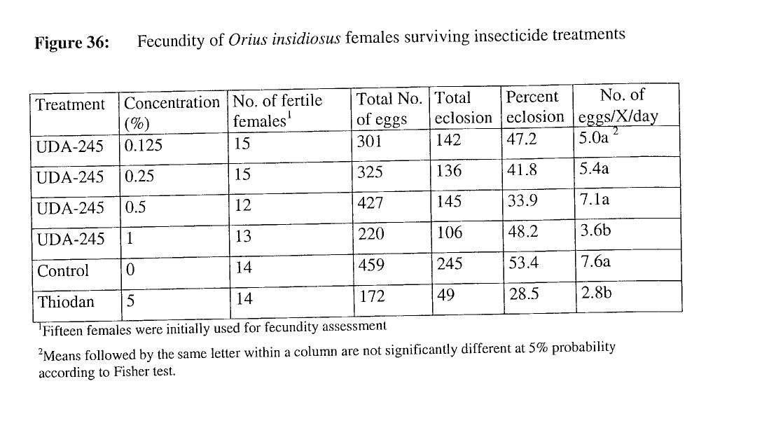

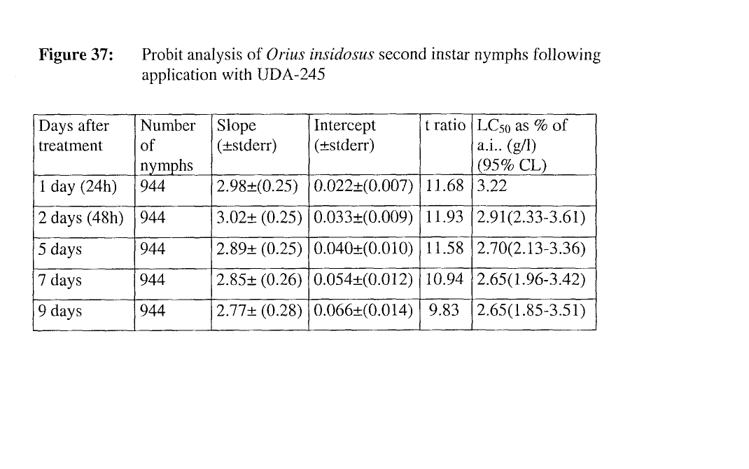

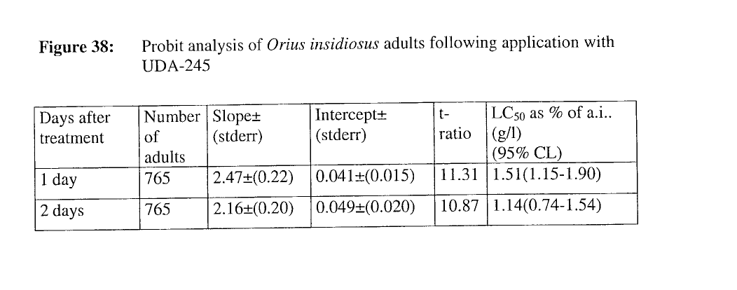

The results from the fedundity assessment assay (FIG. 36) showed that almost all females tested had laid eggs. There were few surviving females to test for fecundity following treatments with Avid, Cygon, Trounce and UDA-245 at concentrations of 2, 4 and 8%. The mean number of eggs laid per female per day in the control treatment was 7.6 which was almost 4 times the minimum number of 2 eggs per female per day set by the IOBC standards for fecundity for Orius leavigatus, a closely related species of O. insidiosus. The lowest rate was 2.8 eggs per female per day obtained in the treatment with Thiodan followed by UDA at 0.5% concentration with 3.6 eggs per female per day and both were significantly different from the rate obtained with the water control (7.6 eggs per female per day). The date rate of eggs laid in the UDA-245 treatments at concentrations of 0.25% (5 eggs) and 0.5% (5.4 eggs) were not significantly different from the number of eggs laid in the control. The eclosion rate varied from 28.5% in the Thiodan treatment to 53% in the control. There was 33.9% egg eclosion in the UDA-245 at 0.5% concentration treatment. LC₅₀ values for Orius nymphs were 2.65%, 9 days following treatment with UDA-245 (FIG. 37) and for adults were 1.14%, 2 days following treatment with UDA-245 (FIG. 38).

### Example XIII

### Other plant extracts having acaricidal activity

Whole plants of A. absinthium and of T. vulgare were harvested in full bloom in the fall of 1993 from a cultivated plot at the Agriculture and Agri-Food Canada experimental farm at L'Acadie, Quebec, Canada. A Microwave Assisted Process (MAP™) and two variants of steam distillation i.e. Distillation in Water (DW) and Direct Steam Distillation (DSD) (Duerbeck, K., 1993), were used to extract the fresh plant material.

Extraction using the MAP process involved using whole plant parts that were shredded (20g) and immersed in 100 ml of hexane and irradiated at 2450 Mhz for 90 seconds at an instensity of 675 W. Distillation in water (DW) and DSD were carried out as previously described. Briefly, a 380L distillator with a capacity for processing ca. 20 kg of plant material was used. During the process of DW, plant material was completely immersed in an appropriate volume of water which was then brought to a boil by the application of heat with a steam coil located at the based of the still body.

In DSD, the plant material was supported within the still body and packed uniformly and loosely to provide for the smooth passage of steam through it. Steam was produced by an external generator and allowed to diffuse through the plant material from the bottom of the tank. The rate of entry of the steam was set at (300 ml/min). With both methods, the oil constitutents are released from the plant material and with the water vapor are allowed to cool in a condenser to separate into two components, oil and water.

Thirty adult female mites were placed on their dorsum with a camel hair brush on a double-sided adhesive tape glued to a 9 cm Petri dish (Anonymous, 1968). Three dishes wer prepared for each concentration of the oil extracted by the three methods and the control, i.e., water, for a total of 90 mites per extraction method per treatment day.

For each application (one per Petri dish), 1 mlof each preparation and of microfiltered water for the control was added with a Gilson Pipetman® P-1000 to the reservoir of the spray nozzle of a Potter Spray Tower mounted on a stand and connected to a pressure guage set at 3 PSI. Petri dishes were weighed before and immediately after each application and, on average, 205 mg (±42; n=50) of solution was deposited on each dish, representing 2.1 (1%), 4.1 (2%), 8.2 (4%) and 16.4 mg/cm² (8%) of oil deposited with each concentration.

The entire procedure was followed twice (1 and 2% of A. absinthium MAP and 4% of T. vulgare MAP solutions) and three times (the remaining MAP and all DW and DSD solutions of both plant species). The third tests using MAP extracts were not done because of insufficient quantities of the oil.

Mite mortality was assessed 24 and 48 h after treatment. As previously, mites that failed to respond to probing with a fine camel hair brush with movements of the legs, proboscis or abdomen were considered dead. Results of the 48 h counts were subjected to Probit analysis using the POLO computer program (LeOra Software, 1987). Mortalities were entered with corresponding weighed doses (mg/cm²) to take into consideration variability in application rate. The significance of differences in LC₅₀ values was determined by comparing the 95% confidence intervals computed by POLO (LeOra Software, 1987).

Analysis of the oils

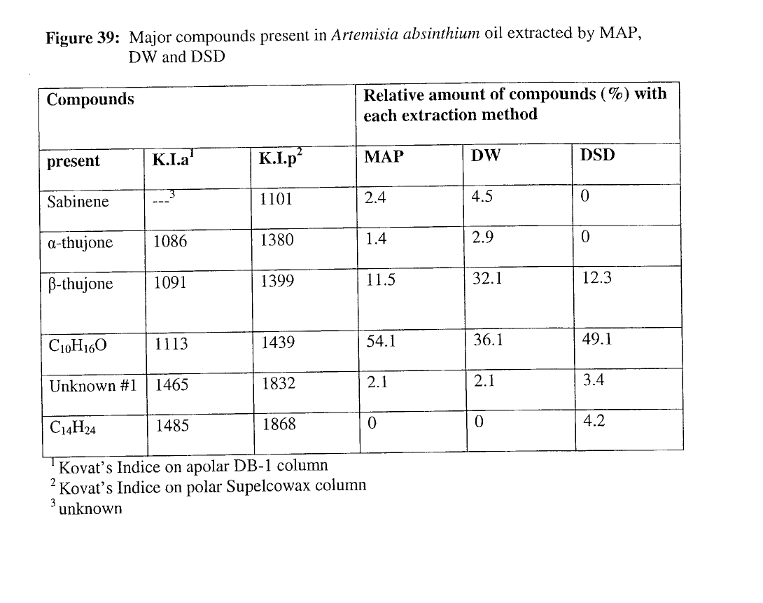

Chromatographic analysis of the oils extracted from A. absinthium indicated differences in chemical composition between extraction methods (FIG. 39). Both sabinene and α-thujone were absent in the DSD oil and present in the MAP and DW oils and a compound identified as a C₁₅H₂₄ was present in DSD but absent in MAP and DW.

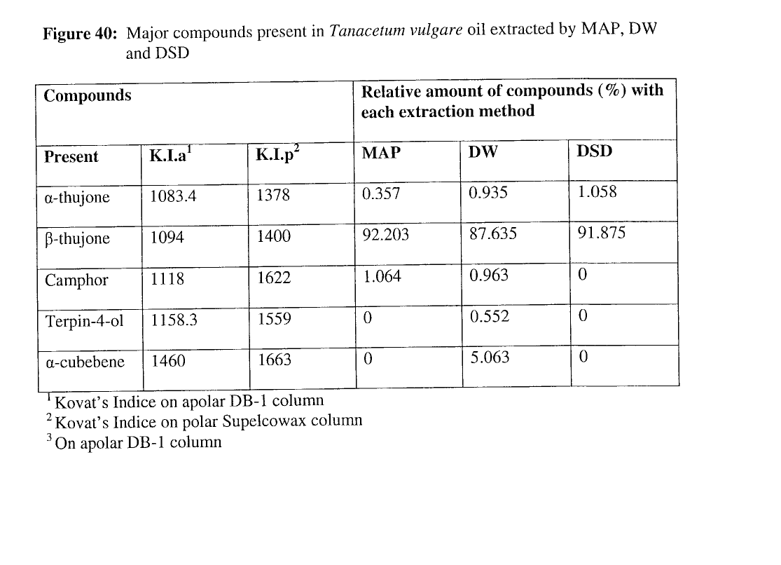

In T. vulgare extracts, β-thujone was the major component of all three extraction techniques (MAP:92.2%; DW 87.6%; DSD: 91.9%) (FIG. 40). Terpin-4-ol and α-cubebene were present in the DW extract and absent in MAP and DSD.

Bioassay results

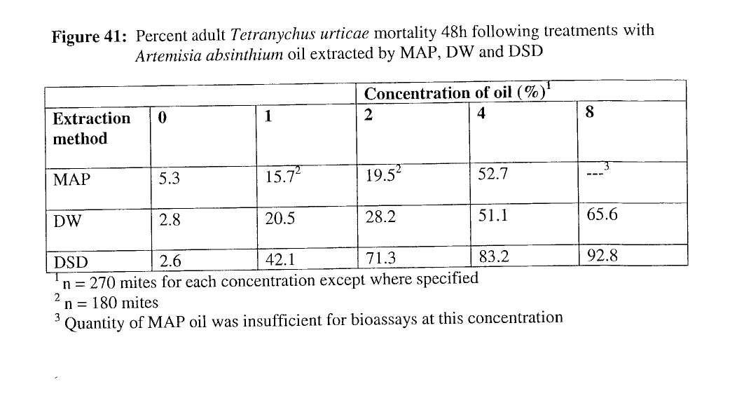

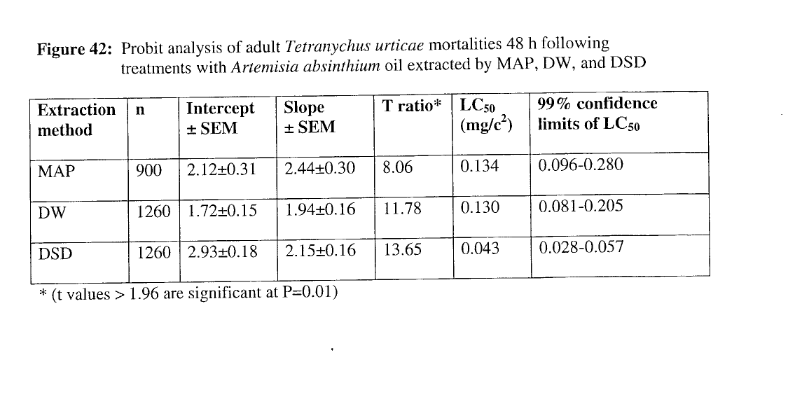

After 48 h, all three extracts (MAP, DW, and DSD) of A. absinthium were lethal to T. urticae (FIG. 41). However, there was variability in the degree of toxicity of the extracts to the two-spotted spider mite. Thus, at 4% concentration, oil extracted by the MAP and the DW methods caused 52.7 and 51.1% mortality respectively, whereas oil extracted by DSD resulted in 83.2% mortality. LC₅₀ values obtained for oil extracted by MAP (0.134 mg/cm²) and with the DW (0.130 mg/cm²) whereas the LC₅₀ of the oil extracted by DSD was significantly lower (0.043 mg/cm²) (FIG. 42).

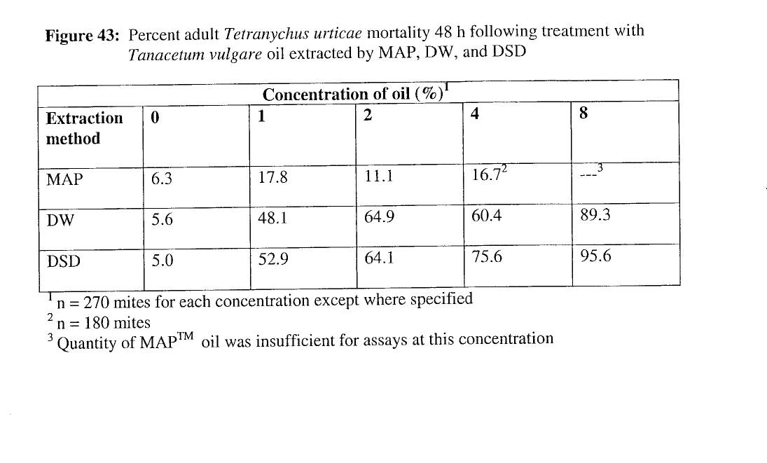

The T. vulgare extracts were also lethal to the two-spotted spider mite (FIG. 43), though extracts obtained by DW and DSD had greater acaricidal effect than the extract obtained by the MAP process. At 4% concentration, the oil extracted by the DW and DSD methods caused 60.4 and 75.6% mortality respectively, while oil extracted by MAP gave 16.7% mortality.

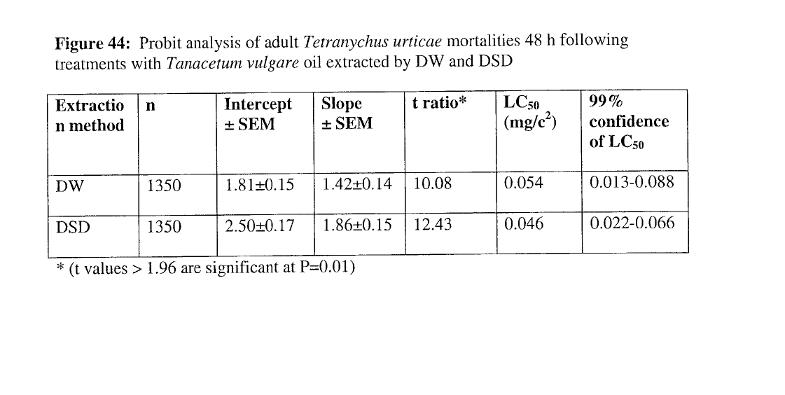

Probit analysis of mortality data obtained from bioassays with the DW and DSD methods could be compared; however analysis of the MAP mortality data gave unreliable results because of the high variation in % mortality values between replicates treated at the same concentration (FIG. 44). It is likely that this variation is due to the physical properties of the MAP extract. During this process, organic compounds such as waxes and resins were released from plant cells along with the essential oils. These products may not have been adequately mixed by the Alkamuls-EL620 emulsifier resulting in a heterogenous solution.

While some variation has been observed in the bioassays with A. absinthium and T vulgare extracts, the present invention has nevertheless shown that A. absinthium oil extracted by DSD is more effective at controlling the spidermite than the A. absinthium oils extracted by the other methods. The sesquiterpene C₁₄H₂₄ compound, present at 4.2% in DSD and absent in the other two extracts (FIG. 39), may be responsible for the higher degree in biological activity. However, identification of the unknown C₁₅H₂₄ compound in A. absinthium, and bioassays with individual compounds using the same three extraction methods, will be necessary for the determination of the active ingredients found in A. absinthium oil.

The similarity in biological response between the oil of tansy extracted by DW and DSD, implies that terpin-4-ol and α-cubebene (present in DW nad not in DSD) contribute very little to the acaricidal activity of the oil extracted by DW. Because of the considerably high % of β-thujone in all three extracts, this component is likely to be the main active ingredient (a.i.) with negligable activity attributable to the other chemical constituents. This would explain the similar results obtained from DW extracts at 4% concentration (60.4% mortality and 87.6% β-thujone) and DSD extracts (75.5% mortality and 91.88% β-thujone) but does not account for the low mortality with the MAP extract (16.7% mortality and 92.2 β-thujone). The MAP extract may not have been adequately emulsified in the solution due to the presence of waxes and resins.

Identification of the active ingredient(s) in an extract is essential for registration when developing a botanical pesticide. Variabilty in response from a series of essential oil extracts must be minimized in order to obtain consistency in toxicity of a product. In addition, other variables such as phenological age of the plant, % humidity of the harvested material and plant parts selected for the extraction must be considered for the extraction of oils with the highest biological activity (as seen above). DSD is the most widely accepted method for the production of essential oils on a commercial scale and should be considered for large-scale production of a biologically active oil because, besides producing oil of greater toxicity in the case of A. absinthium, it is less expensive and yields are comparable to that of the other extraction methods (Chiasson and Belanger, unpublished results). The amount of energy required to generate steam in DSD is considerably lower than that required to boil water for the DW process. MAP is still experimental, and cannot yet be considered for large scale production.

### Example XIV

### Fungicidal efficacy of the essential oil extract and compositions thereof Fungicidal efficacy is tested in the laboratory or in greenhouse trials.

Laboratory tests

The fungicidal efficacy of an essential oil can be done in the laboratory using several methods. One method incorporates the test samples in an agar overlay in a Petri dish. A second method would use a filter disk saturated with the test samples and placed on top of untreated agar. Both systems are challenged with fungal plugs cut from lawns of indicator organisms at the same stage of growth. The plates will be incubated at 30° C. for 5-10 days with visual observations and the zone of inhibition measured and recorded. A positive control, i.e. a commercially available fungicide and a negative control, i.e. water are tested in the same way.

Greenhouse tests

The following are tests done on five disease organisms (Botrytis cinerea, Erysiphe cichoracearum or Sphaerotheca fuliginea, Rhizoctonia solani, Phytophthora infestans) in the greenhouse.

Botrytis cinerea. Tomato plants are seeded and grown following current commercial practices for greenhouse tomato production. About 2 months following seeding, lesions are made on the leaves and the stem (5 lesions/plant) and inoculated with a suspension of 3×10⁶ spores of B. cinerea, 2 ml per lesion. Treatments are then applied to the plants. A positive control, i.e. a commercially available fungicide and a negative control, i.e. water are also tested and all treatments are done in a randomized block design.

The length of lesions are measured every two weeks over a period of 3 months, then the number of fruit, the total weight of fruit and the average weight of fruit are calculated during the entire production period of the plant. The experiment is repeated and the effect of treatments is subjected to an analysis of variance (ANOVA) and means are compared with a LSD test. Erysiphe cichoracearum or Sphaerotheca fuliginea. These disease organisms are obligatory parasites that do not have the capacity to survive in absence of its host. Therefore to provide the inoculum for the test, cucumber leaves are taken from an infested greenhouse. The conidia present on these leaves will transfer onto cucumber plants grown for the experiment one or two months previously. New plants are periodically infested in this manner in order to increase the inoculum.

Treatments are then applied to the plants before or after inoculation depending on the type of fungicide used. A positive control, i.e. a commercially available fungicide and a negative control, i.e. water are also tested and all treatments are done in a randomized block design.

The effect of the disease is evaluated on individual leaves of all plants using a index of infestation from 0 to 5 (0=absence of blemish and 5=80-100% of the leaf surface with blemishes). The degree of the infestation is evaluated 3, 7, and 14 days following inoculation and reported in averages per plant. The experiment is repeated and the effect of treatments is subjected to an analysis of variance (ANOVA) and means are compared with a LSD test.

Rhizoctonia solani. An isolate of Rhizoctonia solani is produced on a culture media (PDA) 3 days before inoculation and a plug of the disease is then transferred to Erlenmeyer flasks filled with a YMG broth for 5 days. The mycelium is filtered, suspended in distilled water and blended. Seeds of tomato are used and sterilized on the surface using successive ethanol 70%, bleach and distilled water solutions. A suitable sterile potting soil mix is used in which 60 mg blended mycelium is inoculated per 100 g of potting soil.

Tests are done in bedding boxes of 72 cells/box and 3 boxes are used per treatment. The boxes are spread out in a randomized arrangement in a controlled atmosphere growth chamber the following conditions: 20° C. during the day and 16° C. at night, 16 hours of light, 162 umol of light intensity and 60% humidity. The boxes are incubated in the growing chambers during 3 weeks. Treatments are then applied to the young plants before or after inoculation depending on the type of fungicide used. A positive control, i.e. a commercially available fungicide and a negative control, i.e. water are also tested and all treatments are done in a randomized block design.

Plants are examined each week and the incidence of the disease is measured as well as the degree of infestation on a scale of 0 to 5 (0=absence of infestation and 5=80-100% of the leaf surface attacked). The experiment is repeated and the effect of treatments is subjected to an analysis of variance (ANOVA) and means are compared with a LSD test.

Phytophthora infestans. On tomato plants. Tomato plants are seeded and grown following current commercial practices for greenhouse tomato production. About 2 months following seeding, leaves and stems are inoculated with a suspension of 1×10⁴ spores of P. Infestans until the plant surfaces are completely covered. Treatments are then applied. A positive control, i.e. a commercially available fungicide and a negative control, i.e. water are also tested and all treatments are done in a randomized block design.

Percent damage or presence of lesions is evaluated every 3-4 days for a period of 2 weeks on leaves that had been identified previously (15-30 leaves per plant). The experiment is repeated and the effect of treatments is subjected to an analysis of variance (ANOVA) and means are compared with a LSD test.

On potato plants. Potato tubers are sown and grown in pots of 6-8 inches. About 1,5 months after seeding, the leaves and stems of the plants are inoculated with a suspension of 1×10⁴ spores of P. Infestans until the plant surfaces are completely covered. Treatments are then applied. A positive control, i.e. a commercially available fungicide and a negative control, i.e. water are also tested and all treatments are done in a randomized block design.

Percent damage or presence of lesions is evaluated every 3-4 days for a period of 2 weeks on leaves that had been identified previously (15-30 leaves per plant). The experiment is repeated and the effect of treatments is subjected to an analysis of variance (ANOVA) and means are compared with a LSD test.

What is claimed is:

1. An essential oil extract derived from plant material comprising, α-terpinene, ρ-cymene, limonene, carvacrol, carveol, nerol, thymol, and carvone, and having acaricidal activity.

2. The essential oil extract according to claim 1, wherein said essential oil extract has insecticidal activity.

3. The essential oil extract according to claim 1, wherein said essential oil extract demonstrates a residual effect that meets general recommendations of Integrated Pest Management programs.

4. The essential oil extract according to claim 1, wherein said plant material is from Chenopodium.

5. The essential oil extract according to claim 4, wherein said plant material is from Chenopodium ambrosioides.

6. A pesticidal composition for the control of phytophagous acari, comprising an effective amount of the essential oil extract of claim 1 and a suitable carrier.

7. The pesticidal composition according to claim 6, wherein said carrier is a suitable emulsifier.

8. The pesticidal composition according to claim 7, wherein said emulsifier is a blend of at least one non-anionic emulsifier and at least one anionic emulsifier.

9. The pesticidal composition according to claim 7, wherein said emulsifier is a non-anionic emulsifier.

10. The pesticidal composition according to claim 7, wherein said emulsifier is an anionic emulsifier.

11. The pesticidal composition according to claim 6, wherein said composition comprises 0.125% to 10% relative percentage volume of said essential oil extract.

12. The pesticidal composition according to claim 11, wherein said composition comprises 0.25% to 2% relative percentage volume of said essential oil extract.

13. The pesticidal composition according to claim 6, wherein said composition comprises 5% to 50% relative percentage volume of said essential oil extract.

14. A pesticidal composition for the control of phytophagous insects, comprising an effective amount of the essential oil extract of claim 2 and a suitable carrier.

15. A method for controlling phytophagous acari, which comprises applying to a locus where control is desired an acaricidally-effective amount of the pesticidal composition of claim 6.

16. A method for controlling phytophagous insects, which comprises applying to a locus where control is desired an insecticidally-effective amount of the pesticidal composition of claim 14.

17. A method for producing an essential oil extract derived from plant material for use in controlling phytophagous acari comprising:
(a) harvesting the plant material;
(b) extracting the essential oil extract by steam distillation; and
(c) recuperating the essential oil extract.

18. An essential oil extract produced according to the method of claim 17.
